(19) United States
(12) Patent Application Publication
(10) Pub. No.: US 2026/0288807 A1
(43) Pub. Date: Sep. 24, 2026

(54) SYSTEM

(71) Applicant: SoftBank Group Corp., Tokyo (JP)

(72) Inventor: Kengo KUWANA, Chiyoda-ku, Tokyo (JP)

(73) Assignee: SoftBank Group Corp., Tokyo (JP)

(21) Appl. No.: 19/566,986

(22) Filed: Mar. 14, 2026

(30) Foreign Application Priority Data
Mar. 19, 2025 (JP) 2025-045066

(51) Int. Cl. G06F 16/3329; G06F 40/295

(52) U.S. Cl. CPC G06F 16/33295; G06F 40/295

(57) ABSTRACT

A system includes a processor that is configured to receive an input representing a user interest, analyze the user interest by using a natural language processing technique and generate a prompt for instructing a generative AI model to generate information based on the analyzed user interest, and input the generated prompt into the generative AI model and generate information on an unknown field by using the generative AI model.

### CROSS-REFERENCE TO RELATED APPLICATION

This application is based on and claims priority under 35 USC 119 from Japanese Patent Application No. 2025-045066 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information provision systems based on user interests mainly perform search or recommendation within domains that are already explicitly known to the user or directly match keywords input by the user. As a result, such systems tend to repeatedly present similar or redundant information, and they are not effective in leading the user to new, unknown fields that are implicitly relevant to the user's interests. In addition, when generative AI models are used, user inputs are often passed to the models as raw or minimally processed text, without being converted into prompts that are optimally structured for information generation. Consequently, the quality, depth, and relevance of the generated information may be limited, and the generative AI model may not fully demonstrate its capabilities. Furthermore, existing systems frequently lack a mechanism for systematically analyzing user input data and designing prompts that contain specific instructions tailored to the characteristics of the generative AI model, which makes it difficult to stably obtain high-quality information related to the user's interests and unknown fields.

### SUMMARY

In order to solve the above problems, the present invention provides a system comprising a processor, wherein the processor is configured to receive an input representing a user interest, analyze the user interest by using a natural language processing technique, and generate a prompt for instructing a generative AI model to generate information based on the analyzed user interest. The processor is further configured to input the generated prompt into the generative AI model and generate information on an unknown field by using the generative AI model. The processor is also configured to use, as the generative AI model, a model that has been trained in advance on a large-scale dataset, thereby generating, based on the prompt, information related to the user interest with high coverage and richness. In addition, the processor is configured to analyze user input data and design the prompt to include specific instructions for information generation, such that the generative AI model can generate the information most effectively. By combining natural language processing for interest analysis, prompt generation including detailed instructions, and a pre-trained generative AI model, the system of the present invention enables the provision of high-quality information not only directly related to the user's explicit interests but also belonging to unknown yet relevant fields, thereby addressing the limitations of conventional information provision systems.

The term “processor” refers to a hardware or software processing unit, such as a central processing unit (CPU), a graphics processing unit (GPU), a microcontroller, or a combination of such units, that executes instructions to perform the functions specified in the claims.

The term “user interest” refers to information indicating a preference, concern, intention, or area of curiosity of a user, expressed for example as text, keywords, phrases, or natural language statements input by the user.

The term “natural language processing technique” refers to a computational method or algorithm for processing human language, including but not limited to tokenization, parsing, part-of-speech tagging, semantic analysis, intent detection, topic extraction, or embedding-based analysis.

The term “prompt” refers to a text or structured input sequence that is provided as an instruction to a generative AI model, the prompt specifying, at least in part, the content, style, scope, or format of information to be generated by the generative AI model.

The term “generative AI model” refers to a machine-learned model, such as a large language model or other generative model, that has been trained to generate output data, including text, based on an input such as a prompt.

The term “information on an unknown field” refers to information about a technical or non-technical field that is not explicitly included in the user interest and that the user is presumed not to have directly requested or previously explored, but that is inferred to be relevant based on the analysis of the user interest.

The term “large-scale dataset” refers to a dataset comprising a large number of data samples, such as documents, text corpora, or other content, sufficient to train a generative AI model to generalize across a wide variety of topics and linguistic expressions.

The term “user input data” refers to data provided by the user to the system, including at least the user interest and optionally additional context such as previous queries, interaction history, preferences, or feedback.

The term “specific instructions for information generation” refers to detailed directives contained in the prompt, including for example desired topic focus, explanation depth, style, constraints, examples, or output format, which are intended to guide the generative AI model to generate information in a desired manner.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

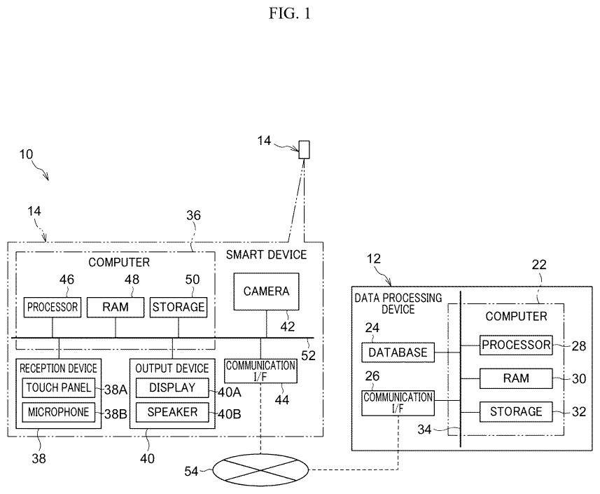

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

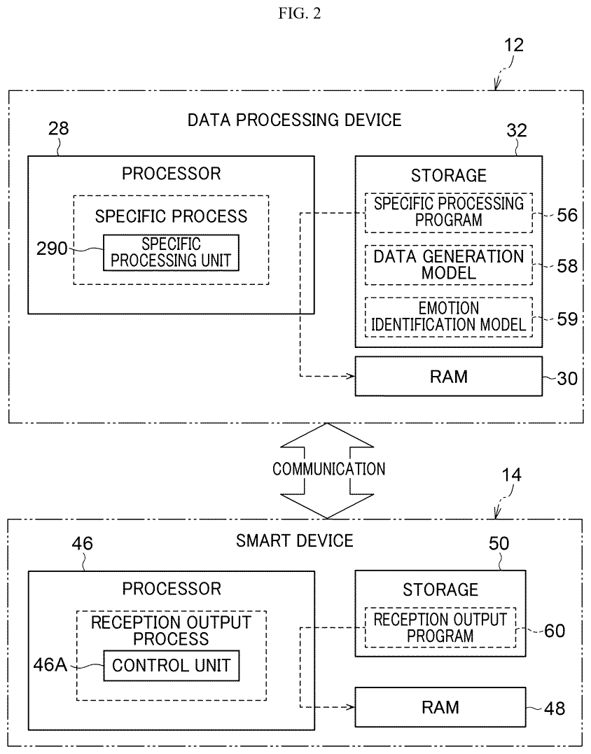

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional information provision systems that utilize machine learning or rule-based techniques, a processor typically receives a user query and either performs keyword matching against a content repository or forwards the raw text directly to a generative AI model. Such systems suffer from several technical shortcomings at the level of computer operation and resource utilization.

First, when a processor directly forwards unstructured natural language input to a generative AI model without intermediate structuring, the generative AI model must internally infer the user's domain of interest, desired level of detail, and output format solely from ambiguous context. This often leads to inefficient token utilization, redundant internal computation, and generation of responses that are either overly broad, insufficiently relevant, or not tailored to the user's knowledge level. As a result, the computing resources of the generative AI model, such as processor cycles and memory bandwidth, are consumed for processing noise and ambiguity in the input, thereby reducing throughput and increasing latency.

Second, many existing systems lack an explicit, machine-processable representation of the user's interest that can be reused across multiple interactions. Without such structured information, a processor must repeatedly perform full analysis of each new user request, even when the requests are semantically related. This repetition leads to unnecessary computation, inefficient use of memory and cache structures, and difficulty in optimizing server-side scheduling and load balancing for natural language processing tasks.

Third, typical systems do not explicitly control the internal behavior of a generative AI model through a systematically constructed prompt sentence that encodes domain information, emphasis information, and output configuration. Instead, prompt design is often ad-hoc and static, resulting in suboptimal guidance to the model. This lack of structured prompt generation causes the model to generate extraneous content and increases the number of inference iterations required to arrive at a useful answer, thereby degrading system responsiveness and scalability on shared computing infrastructure.

Fourth, conventional systems frequently return the output of a generative AI model as an unstructured text string. Such unstructured output requires additional parsing and ad-hoc formatting when displayed across heterogeneous terminal devices, leading to duplicated transformation logic, inconsistent user interfaces, and additional processing overhead in client and server components. This hinders efficient rendering pipelines and complicates integration with other data processing modules that expect structured data formats.

Accordingly, there is a need for an improved computer-implemented system in which a processor (i) converts user interest expressed in natural language into structured information representing subject and auxiliary information, (ii) automatically generates a prompt sentence that encodes explicit instruction items for a generative AI model, and (iii) converts generated information from the model into a hierarchically structured data format suitable for efficient transmission and rendering. By addressing these issues, the invention seeks to improve the technical performance of information generation systems, including reduced computational overhead, more effective utilization of model inference resources, lower response time, and more efficient data flow between server and terminal devices.

The specific processing by the specific processing unit 290 of the data processing device 12 in Example 1 is realized by the following means.

The present invention provides a server comprising a processor and a memory storing instructions which, when executed by the processor, cause the processor to receive natural language data indicating an interest of a user from a terminal device, perform language processing including segmentation, part-of-speech assignment, and contextual analysis on the natural language data to generate structured information representing content of the interest by extracting subject information and auxiliary information from the natural language data, generate a prompt sentence by embedding into the structured information at least one instruction item including a target domain, a level of explanation, and an output format, generate generation instruction information for a generative AI model based on the prompt sentence, input the generation instruction information into a pre-trained generative artificial intelligence model to acquire generated information including information related to a field unknown to the user, convert the generated information into a structured data format having a hierarchical structure including heading information, summary information, and detailed information, format the structured data format as document data for display, and transmit the document data for display to the terminal device via a communication network. This enables the server to reduce ambiguity in inputs to the generative AI model, to guide the generative AI model by means of a systematically constructed prompt sentence, to decrease unnecessary internal computation and token consumption during model inference, and to output hierarchically structured generated information that can be efficiently transmitted, rendered, and reused across interactions, thereby improving overall computational efficiency, response latency, and scalability of the information generation system.

The term “user” refers to a human or automated entity that provides natural language input indicating an interest, and that receives information generated by the system via a terminal device.

The term “terminal device” refers to an information processing apparatus, such as a computing device with a user interface and communication function, that transmits natural language data indicating a user's interest to a server and displays document data received from the server.

The term “server” refers to an information processing apparatus, typically including at least one processor and a memory, that executes instructions to receive, analyze, and transform natural language data and to generate and deliver structured information to a terminal device.

The term “processor” refers to a hardware execution unit, such as a central processing unit or other computing circuitry, configured to execute instructions to perform language processing, prompt generation, model invocation, and data structuring operations described herein.

The term “memory” refers to a non-transitory computer-readable storage medium, such as semiconductor memory or magnetic storage, that stores instructions and data used by the processor to perform the functions of the system.

The term “natural language data” refers to character data or equivalent encoded data representing human language expressions, such as sentences or phrases, indicating an interest of a user.

The term “language processing” refers to computational processing performed by the processor on natural language data, including at least segmentation processing, part-of-speech assignment processing, and contextual analysis processing, to extract structured information from unstructured text.

The term “segmentation processing” refers to processing that divides natural language data into units such as words, tokens, or morphemes suitable for further linguistic analysis.

The term “part-of-speech assignment processing” refers to processing that assigns grammatical categories, such as noun, verb, or adjective, to each unit generated by segmentation processing.

The term “contextual analysis processing” refers to processing that analyzes relationships between units of natural language data, including syntactic and semantic relationships, to infer meanings such as subject matter, modifiers, and overall intent.

The term “subject information” refers to information extracted from natural language data that represents a main topic or domain of interest indicated by the user.

The term “auxiliary information” refers to information extracted from natural language data that supplements the subject information, including modifiers such as desired detail, time aspect, or specific subtopics.

The term “structured information” refers to information generated from natural language data in which subject information and auxiliary information are represented as machine-processable data elements, such as fields or attributes, defining content of the user's interest.

The term “target domain” refers to information indicating a particular field or category of knowledge, such as a technical domain or application area, to which generated information is to be directed.

The term “level of explanation” refers to information indicating a depth or complexity level of explanation requested for generated information, such as an introductory, intermediate, or advanced level.

The term “output format” refers to information indicating a desired configuration or style of generated information, such as sectional structure, list usage, or presentation style for display.

The term “instruction item” refers to a unit of control information, including at least one of target domain, level of explanation, and output format, that is embedded into a prompt sentence to guide behavior of a generative AI model.

The term “prompt sentence” refers to a natural language expression generated by the processor that incorporates structured information and one or more instruction items, and that is supplied to a generative AI model to specify a content and style of information to be generated.

The term “generation instruction information” refers to information derived from the prompt sentence that is provided as input to a generative AI model to cause the generative AI model to generate information related to the user's interest.

The term “generative artificial intelligence model” refers to a machine-learned model that, based on input including a prompt sentence, probabilistically generates new data, such as text, that is not a mere retrieval of stored data but is inferred from trained parameters.

The term “pre-trained” refers to a state of a generative artificial intelligence model that has been trained in advance using a large-scale training information set before being used by the system to generate information in response to a user's interest.

The term “large-scale training information set” refers to an information collection comprising a large number of data instances, such as text documents, used for training a generative artificial intelligence model to learn language patterns and knowledge.

The term “generated information” refers to information output by the generative artificial intelligence model in response to generation instruction information, including information related to the user's interest and to fields that may be unknown to the user.

The term “unknown field” refers to a field of knowledge or topic that is not explicitly specified in the user's input but is inferred as related or beneficial by the system and is included in the generated information.

The term “related field” refers to a field of knowledge associated with the subject information extracted from the user's interest, which can be used to extend or complement explanations provided to the user.

The term “example information” refers to information included in generated information that provides concrete instances, use cases, or scenarios suited to a knowledge level of the user.

The term “domain information” refers to information included in structured information that indicates an interest field or category derived from the user's natural language data.

The term “emphasis information” refers to information included in structured information that indicates a depth or priority of interest of the user with respect to certain aspects of the subject information.

The term “control information” refers to information included in structured information that indicates whether and how additional knowledge or extended content should be provided to the user.

The term “information structure” refers to a defined arrangement of data elements, including at least domain information, emphasis information, and control information, that collectively represent the user's interest in a machine-processable format.

The term “hierarchical structure” refers to a structure in which information elements, such as heading information, summary information, and detailed information, are arranged in multiple levels with parent-child relationships.

The term “heading information” refers to information that identifies main sections or topics in generated information and is used as upper-level elements in a hierarchical structure.

The term “summary information” refers to information that concisely describes the essence of generated information or a section thereof and is positioned beneath heading information in a hierarchical structure.

The term “detailed information” refers to information that provides in-depth explanation, elaboration, or examples under corresponding heading information and summary information in a hierarchical structure.

The term “structured data format” refers to a data representation in which generated information is encoded according to a defined schema, including a hierarchical arrangement of heading information, summary information, and detailed information, suitable for machine processing and rendering.

The term “document data for display” refers to structured data that has been formatted into a representation, such as markup-based data, suitable for presentation on a display device of a terminal.

The term “communication path” refers to a wired or wireless communication medium and associated protocols that enable transmission of data between a server and a terminal device.

The term “communication network” refers to a network infrastructure, including at least one communication path, through which the server and the terminal device exchange data.

The term “token” refers to a unit of text, such as a word, subword, or symbol, used internally by a language processing pipeline or a generative artificial intelligence model for analysis and generation.

The term “token consumption” refers to a quantity of tokens processed or generated by a generative artificial intelligence model during inference in response to a prompt sentence or generation instruction information.

The term “model inference” refers to a computational process in which a generative artificial intelligence model computes output data, such as generated information, based on input data and trained parameters.

The term “response latency” refers to a period from receipt of natural language data indicating a user's interest by the server to provision of corresponding document data for display to the terminal device.

The term “scalability” refers to an ability of the system to maintain or improve performance metrics, such as throughput and response latency, when processing requests for multiple users or an increased number of interactions.

In one embodiment, a server includes at least one processor, a main memory, a non-transitory storage device, and a network interface connected to a communication network. The server executes an operating system, such as a general-purpose server operating system, and application software implementing natural language processing, prompt sentence generation, invocation of a generative AI model, and structuring and transmission of generated information. The server communicates with one or more terminal devices operated by users.

A terminal includes a processor, a memory, a display device, an input interface such as a keyboard, pointing device, or touch panel, and a network interface. The terminal executes a web browser or a native application that presents a user interface for inputting a user's interest in natural language and displaying generated information received from the server.

A user operates the terminal to input natural language data indicating an interest. The terminal displays an input field within a web page or application screen. The terminal may also include an audio input device and speech recognition software to convert spoken input into character data. The terminal transmits the resulting natural language data, together with metadata such as a language code and a session identifier, to the server via the network interface using a communication protocol such as HTTPS.

The server receives the natural language data and temporarily stores it in memory. The server executes a language processing module implemented, for example, using a natural language processing framework such as an open-source tokenizer and tagger, to perform segmentation processing and part-of-speech assignment processing on the received natural language data. The server divides the text into tokens representing words or subwords and assigns a grammatical category to each token. The server then executes contextual analysis processing using a contextual language model, such as a transformer-based encoder similar to a BERT-type model, to compute a vector representation for each token and for the entire sentence.

The server uses the combination of token-level and sentence-level vector representations to derive structured information representing content of the user's interest. The server maps the output vectors to an internal information structure that includes subject information and auxiliary information. The subject information corresponds to a main topic, such as “latest AI technologies,” whereas the auxiliary information includes modifiers such as “latest,” constraints such as “detailed explanation,” and hints about the user's knowledge level inferred from word choice and phrasing. The server stores the structured information in a data structure, such as a key-value representation or a record, in memory.

The server applies an algorithm that transforms the structured information into control information used for prompt generation. The server derives domain information indicating an interest field (for example, “artificial intelligence,” “healthcare,” or “education”), emphasis information indicating a depth or priority of specific aspects (for example, “cutting-edge technologies,” “practical applications,” or “ethical considerations”), and control information indicating whether to introduce unknown but related fields (for example, “include related domains such as robotics or data privacy”). This transformation is implemented as a deterministic set of rules combined with similarity computations in the vector space produced by the contextual language model. The server thereby converts unstructured natural language into an information structure with explicitly labeled fields.

The server generates a prompt sentence for a generative AI model by embedding instruction items derived from the structured information into a natural language template. The server selects a template based on the domain information and the user's inferred knowledge level. For example, when the domain information indicates a technical field and the emphasis information indicates the user is a non-expert, the server selects a template configured for explanatory content with simple language and examples. The server fills the template with the subject information, domain information, and constraints from the control information.

For instance, when the user's natural language data is “I want to know about the latest AI technologies,” the server generates a prompt sentence such as: “Please explain in detail the latest AI technologies that the user is interested in. Cover major categories such as large language models, diffusion models, and reinforcement learning, and describe real-world applications in several fields that the user may not yet know. Use clear language suitable for a non-expert and organize the explanation into sections with headings and bullet points.”

In another example, when the user's natural language data is “I want to learn about cutting-edge AI applications in healthcare,” the server generates a prompt sentence such as: “Please explain in detail the latest AI applications in healthcare that the user is interested in. Cover areas such as diagnosis support, medical imaging, personalized medicine, and hospital operations. Use clear language for a non-expert reader and include concrete examples.”

The server converts the generated prompt sentence into generation instruction information, for example by packaging the prompt sentence with configuration parameters such as a maximum token count, a temperature value controlling randomness, and penalties for repeated tokens. The server then transmits the generation instruction information to a generative AI model.

In one embodiment, the generative AI model is a transformer-based neural network trained as a probabilistic generative model using a large-scale corpus of text. The generative AI model includes multiple layers of self-attention and feedforward sub-layers, layer normalization units, and learned embedding parameters. The model has been pre-trained by minimizing a loss function such as a cross-entropy loss over next-token prediction tasks. During training, gradients of the loss function with respect to the model weights are computed via backpropagation, and the model weights are updated using an optimization algorithm such as stochastic gradient descent or an adaptive gradient method. The training dataset includes diverse text documents across multiple domains, and may be augmented by data augmentation strategies such as random masking, shuffling, or synthetic paraphrasing to improve generalization and robustness.

The server executes a model invocation module that sends the prompt sentence and associated parameters to a generative AI model endpoint, which may be hosted locally on the server or on a separate computing device. When the generative AI model runs locally, the server loads model parameters into memory and uses hardware acceleration such as a graphics processing unit or specialized accelerator to perform matrix multiplications and attention computations efficiently. The generative AI model processes the prompt sentence token by token, computes conditional probability distributions over a vocabulary at each generation step, and selects subsequent tokens based on those distributions and the specified parameters.

The server receives generated information as a sequence of tokens representing sentences and paragraphs of explanatory text. The server concatenates the tokens into text strings and analyzes the output to identify implicit section boundaries, bullet-like enumerations, and topic transitions. The server then converts the generated information into a structured data format with a hierarchical structure. The server assigns heading information to top-level topics, summary information to concise descriptions of each section, and detailed information to full explanatory paragraphs and examples under each heading. For instance, the server may assign a heading such as “Overview of Latest AI Technologies,” a summary describing the overall trend, and detailed information listing “large language models,” “diffusion models,” and “reinforcement learning” with their respective descriptions.

The server formats the structured data into document data for display, such as markup-based data. The server maps heading information to heading elements, summary information to introductory text segments, and detailed information to body segments, lists, or tables. The server may include identifiers or metadata in the structured data to facilitate further processing, caching, or re-use across sessions. The server transmits the document data via the communication network to the terminal.

The terminal receives the document data, parses the markup, and renders a visual representation on the display device. The terminal may present headings with larger fonts, summaries as short introductory blocks, and details as scrollable paragraphs. The terminal may also provide interactive controls allowing the user to expand or collapse sections. Because the document data already has a hierarchical structure, the terminal requires less client-side processing to adapt the content to different screen sizes and presentation styles.

The server thereby improves technical performance in several ways. By converting natural language data into structured information before generating a prompt sentence, the server reduces ambiguity in the prompt provided to the generative AI model. This reduction in ambiguity causes the generative AI model to converge more quickly to relevant content, thereby decreasing the average number of tokens generated outside the user's area of interest. As a consequence, the server reduces token consumption, processing time on the computing hardware executing the generative AI model, and bandwidth usage on the communication network.

The server further improves computational efficiency by reusing structured information across multiple user interactions. When the user issues follow-up questions that are semantically related to a previous query, the server can retrieve the previously generated structured information and modify only selected fields such as emphasis information or control information. This avoids repeating full-scale contextual analysis on each new input, thus reducing CPU usage and memory bandwidth requirements.

The server uses explicit instruction items in the prompt sentence to control behavior of the generative AI model in ways not achievable by manual prompting alone. By embedding domain information, level of explanation, and output format information into the prompt sentence, the server causes the generative AI model to focus its internal attention on relevant parts of the vocabulary and parameter space. This structured guidance leads to more consistent section structures and better alignment with the user's knowledge level, thereby reducing the need for post-processing and re-generation.

The server implements rules and non-conventional procedures for constructing the prompt sentence that differ from typical manual prompt design. For example, the server may enforce a rule that the prompt sentence always explicitly names at least one related field inferred from the domain information, thereby instructing the generative AI model to generate content that extends beyond the user's original query but remains topically relevant. The server may also apply a non-linear mapping from emphasis information to instructions about detail level and example density, such that small changes in emphasis information can produce larger changes in the granularity of explanation. These rules constitute algorithmic improvements that systematically produce more efficient and targeted prompts than a human user can reasonably generate for each request.

The server also improves data management and rendering efficiency. Because the server outputs generated information in a structured data format with a hierarchical structure, downstream components such as content indexing modules, caching layers, and personalization engines can operate on structured fields rather than on unstructured text. This reduces the complexity and computational cost of parsing operations and facilitates selective retrieval or partial updates of content. For example, the server can update only summary information without regenerating all detailed information, or can replace one section of detailed information without recomputing headings and summaries.

In another embodiment, the server introduces additional technical variations. The server may maintain a cache of structured information and corresponding prompt sentences, keyed by a representation of the user's interest derived from vector embeddings. When a new user query is similar to a stored interest, the server may reuse or adapt an existing prompt sentence, thereby reducing processing latency. The server may also adapt parameters of the generative AI model invocation, such as shortening the maximum token length or reducing randomness, based on the emphasis information and control information.

In yet another embodiment, the server may employ a different generative AI model architecture, such as an encoder-decoder transformer, and adjust the training procedure accordingly. In such a case, the server still uses structured information and instruction items to generate a prompt sentence or input sequence to the encoder, and the decoder generates explanatory text based on encoded representations and attention mechanisms. The server may refine model behavior by fine-tuning the model on a dedicated training set of prompt-and-response pairs in which domain information, level of explanation, and output format are explicitly annotated, thereby strengthening the correlation between instruction items and generated output characteristics.

The server and terminal operate together to achieve technical effects that go beyond mere automation of human tasks. The server uses advanced language processing, explicit information structuring, and algorithmic prompt generation to optimize internal operations of the generative AI model and the data flows between components. This leads to faster response times, reduced computational load, better resource utilization, and more predictable quality of generated information. The terminal benefits from receiving structured content that is easier to render and adapt to various display devices, reducing client-side processing and improving user-perceived responsiveness.

Through these embodiments and variations, the system provides a concrete implementation that allows others skilled in the art to realize the claimed invention and to understand how the combination of structured information, prompt sentence generation, and generative AI model invocation leads to improvements in computer technology, including processing efficiency, accuracy of content generation, and effective management and presentation of generated data.

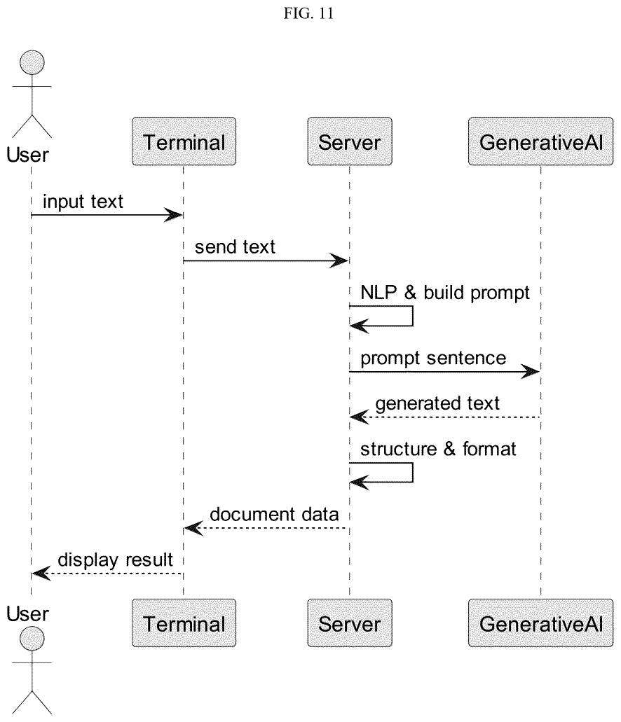

The following describes the processing flow using FIG. 11.

### Step 1

The user operates the terminal to input natural language data indicating an interest. The user types a sentence such as “I want to know about the latest AI technologies” into a text input field, or speaks a similar request using a microphone. The terminal, when receiving spoken input, converts the audio signal into character data using a speech recognition function. The input of this step is a raw user intention in human language, and the output is a text string representing the user's interest stored in the terminal's memory.

### Step 2

The terminal transmits the text string and associated metadata, such as a language code and a session identifier, to the server via a communication network. The terminal encapsulates the text string into a request message, for example an HTTP POST request with a JSON body, and sends it through the network interface. The input of this step is the text string and metadata stored at the terminal, and the output is a structured request message delivered to the server's network stack.

### Step 3

The server receives the request message through a network interface and extracts the natural language data and metadata. The server uses an application framework to parse the message body and stores the raw text and metadata into temporary memory structures. The input of this step is the request message from the terminal, and the output is an internal representation of the user's text (for example, a character sequence) and associated metadata ready for language processing.

### Step 4

The server executes segmentation processing and part-of-speech assignment processing on the natural language data. The server loads a language processing module, such as a tokenizer and tagger, and applies it to the character sequence to divide it into tokens and assign a grammatical category to each token. The server converts the continuous character stream into a list of tokens and creates a corresponding list of part-of-speech tags. The input of this step is the natural language text string, and the output is a token list with associated part-of-speech information.

### Step 5

The server performs contextual analysis processing on the token list to compute vector representations. The server uses a contextual language model, such as a transformer-based encoder, to map each token and the overall sentence into high-dimensional vectors that capture semantic relationships. The processor converts the tokens into numerical IDs, feeds them through multiple attention and feedforward layers, and obtains embeddings for each token and a sentence-level embedding. The input of this step is the token list with part-of-speech tags, and the output is a set of embeddings that numerically encode contextual meaning of the user's interest.

### Step 6

The server generates structured information representing the content of the user's interest from the embeddings and linguistic annotations. The server applies rule-based logic and similarity computations over the embeddings to identify subject information, such as the main topic “AI technologies,” and auxiliary information, such as modifiers like “latest” and desired detail level implied by words such as “know about” or “in detail.” The server then constructs a record or key-value structure whose fields store the identified subject information and auxiliary information. The input of this step is the embeddings and token-level annotations, and the output is a structured information object containing labeled fields describing the user's interest.

### Step 7

The server derives domain information, emphasis information, and control information from the structured information. The server maps the subject information to a domain label, such as “artificial intelligence” or “healthcare,” using semantic similarity thresholds and a domain taxonomy. The server determines emphasis information, such as whether the user focuses on “cutting-edge technologies” or “practical applications,” by analyzing specific modifiers and their embeddings. The server sets control information flags indicating whether to introduce related but unknown fields or to limit output length. The input of this step is the structured information object, and the output is an extended information structure that includes domain information, emphasis information, and control information.

### Step 8

The server generates a prompt sentence by embedding instruction items from the extended information structure into a natural-language template. The server selects a particular template based on the domain information and emphasis information, for example choosing a non-expert explanatory style for a general user. The server then fills placeholders in the template with the subject information and explicit instructions about level of explanation and output format. For example, the server constructs a prompt sentence such as “Please explain in detail the latest AI technologies that the user is interested in. Cover major categories such as large language models, diffusion models, and reinforcement learning, and describe real-world applications in several fields that the user may not yet know. Use clear language suitable for a non-expert and organize the explanation into sections with headings and bullet points.” The input of this step is the extended information structure, and the output is a complete prompt sentence in natural language.

### Step 9

The server converts the prompt sentence into generation instruction information for a generative AI model. The server creates a data structure that combines the prompt sentence with control parameters, such as maximum number of output tokens, a temperature value, and repetition penalties. The server formats this data structure according to the interface specification of the generative AI model endpoint. The input of this step is the prompt sentence and model configuration rules, and the output is a structured set of generation instruction information ready to be transmitted to the generative AI model.

### Step 10

The server transmits the generation instruction information to the generative AI model and initiates model inference. The server sends the prompt sentence and parameters to a model execution environment, which may be hosted locally or remotely, via an application programming interface. The server ensures that the instruction information is serialized in the required protocol format and invokes a call to start generation. The input of this step is the generation instruction information, and the output is a model invocation request received by the generative AI model.

### Step 11

The server receives generated information from the generative AI model as a sequence of tokens or strings. As the generative AI model produces output tokens based on the prompt sentence and its internal parameters, the server collects the tokens, converts them into characters, and concatenates them into paragraphs of text. If the model returns the output in streaming form, the server aggregates partial segments until the model has finished. The input of this step is the token stream or batched outputs from the generative AI model, and the output is one or more complete text passages describing content related to the user's interest and related unknown fields.

### Step 12

The server analyzes the generated text to identify structural elements for a hierarchical representation. The server applies heuristics and pattern-detection algorithms to locate sentences that should serve as headings, summaries, and detailed descriptions. The server may use cue phrases, punctuation, and semantic similarity between sentences to rank them as candidates for heading information or summary information. The input of this step is the raw generated text, and the output is a mapping that associates segments of the text with roles such as heading, summary, and details.

### Step 13

The server converts the generated information into a structured data format having a hierarchical structure. The server creates a data object that includes fields for heading information, summary information, and detailed information, and organizes these fields into parent-child relationships. For each identified heading, the server links associated summary and detail segments under that heading. The input of this step is the mapping of text segments to structural roles, and the output is a hierarchical structured data object representing the full generated content.

### Step 14

The server formats the hierarchical structured data as document data for display. The server maps headings to display elements such as section titles, summaries to introductory snippets, and details to paragraphs and lists. The server applies a document template to generate markup-based data that encodes the hierarchical structure, and includes identifiers or attributes to preserve the logical structure. The input of this step is the hierarchical structured data object, and the output is formatted document data suitable for rendering on a terminal display.

### Step 15

The server transmits the document data for display to the terminal via the communication network. The server encapsulates the document data into a response message, for example an HTTP response with a content type indicating markup-based data, and sends it through the network interface. The input of this step is the document data stored at the server, and the output is a response message delivered to the terminal containing the formatted generated information.

### Step 16

The terminal receives the response message containing the document data and prepares it for rendering. The terminal extracts the markup-based content from the message and passes it to a rendering engine. The terminal may cache the document data locally to support subsequent operations such as scrolling or partial updates. The input of this step is the response message received from the server, and the output is an internal document representation ready for display.

### Step 17

The terminal renders the document data on the display device for the user. The terminal converts heading elements into visually distinct section headers, summary portions into short introductory text regions, and detailed information into paragraphs and lists that can be scrolled or expanded. The terminal may also provide interactive elements such as buttons or links based on structural metadata. The input of this step is the internal document representation, and the output is a displayed user interface that presents the generated information derived from the generative AI model and shaped by the prompt sentence.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information delivery systems typically rely on fixed recommendation rules or simple statistical models that select existing content from a repository based on coarse user attributes or explicit keywords. Such systems do not dynamically generate new content tailored to a user's evolving interests, and therefore fail to expand the user's knowledge into related or unknown fields. In addition, conventional systems often treat the user's natural language input merely as a search query, without performing rich linguistic analysis or systematically transforming the input into optimized instructions for a generative artificial intelligence model.

From a computer technology perspective, existing architectures do not effectively integrate natural language processing, prompt sentence construction, generative artificial intelligence inference, and user behavior feedback into a unified processing pipeline. As a result, processing resources of servers and networks are not used efficiently, and the quality and relevance of generated content are not adaptively improved over time. Further, known systems generally lack a mechanism for maintaining structured associations among user interests, prompt sentences, generated content, and behavioral feedback, which limits the ability of the system to refine its generation logic and to provide transparent generation conditions to the user.

There is a need for a computer-implemented technique that improves how a server interprets user interest text, automatically designs and updates prompt sentences for a generative artificial intelligence model, and structures, stores, and presents generated content in a manner that continuously adapts to user behavior. In particular, there is a need for a technical solution that: (i) transforms unstructured natural language input into machine-interpretable interest representations, (ii) generates optimized prompt sentences based on those representations and behavioral weight information, (iii) orchestrates calls to a generative artificial intelligence model to obtain content including information in fields unknown to the user, and (iv) uses structured storage and retrieval mechanisms to deliver personalized articles or video configuration data with improved efficiency and transparency.

The specific processing by the specific processing unit 290 of the data processing device 12 in Application Example 1 is realized by the following means.

The present invention provides a server comprising a processor and a memory storing instructions which, when executed by the processor, cause the processor to receive user interest information as natural language character data from a terminal via a network; to analyze the received character data using a natural language processing program to perform at least one of morphological analysis, syntactic analysis, and phrase extraction, and to extract therefrom a plurality of terms or topics representing the user's interests; to automatically generate, based on the extracted terms or topics, a prompt sentence for instructing information generation by a generative artificial intelligence model by inserting the extracted terms or topics into a predetermined sentence template; to transmit the prompt sentence to the generative artificial intelligence model via the network and obtain, as a model output, information related to the user's interests and including information in a field that is unknown to the user; to post-process the obtained information by performing at least one operation selected from summarization, segmentation, heading generation, and topic extraction, thereby structuring the obtained information as article data or video configuration data; to store the structured data together with the corresponding prompt sentence and associated user identification information in a data storage device such that the structured data is retrievable in response to a request from the terminal; to collect behavior history data representing at least one of viewing, selection, operation, and dwell time of the user with respect to the structured data presented on the terminal; to compute or update topic-specific weight information for the user based on the behavior history data; and to automatically modify content or structure of a subsequent prompt sentence by using the updated weight information so that subsequent prompt sentences are adaptively optimized for the generative artificial intelligence model. This enables the server-implemented system to technically improve computer operation by converting unstructured user input into optimized prompt sentences, orchestrating efficient generative artificial intelligence inference, adaptively updating generation logic based on behavioral feedback, and delivering personalized, knowledge-expanding content with improved processing efficiency, relevance, and transparency.

The term “user interest information” refers to natural language character data that a user inputs via a terminal interface, expressing the user's preferences, curiosities, or topics of interest.

The term “terminal” refers to an information processing device operated by a user, such as a mobile device, a personal computer, or a similar user-facing computing apparatus that provides a user interface and communicates with a server over a network.

The term “user interface” refers to a software-implemented presentation and input layer on the terminal that allows the user to view information and to input data such as text, commands, or selections.

The term “natural language character data” refers to textual data composed of characters in a human language, such as sentences or phrases, that are directly understandable by human users and are subject to natural language processing.

The term “network” refers to a communication infrastructure, including at least one of wired networks, wireless networks, and the Internet, that enables data exchange between the terminal, the server, and external services.

The term “server” refers to an information processing apparatus, typically including at least one processor and at least one memory, that executes programs to provide back-end functionality, including natural language processing, prompt generation, content generation, and data storage.

The term “processor” refers to a hardware execution unit, such as a central processing unit or a microprocessor, capable of executing instructions stored in a memory to perform the functions described in the claims.

The term “memory” refers to a computer-readable storage medium, such as volatile memory or non-volatile memory, that stores instructions and data used by the processor.

The term “natural language processing program” refers to software that analyzes natural language character data, including at least one of tokenization, morphological analysis, syntactic analysis, phrase extraction, and topic extraction, to derive structured information from unstructured text.

The term “morphological analysis” refers to a process of decomposing text into morphemes or word units and determining grammatical attributes such as part of speech, inflection, or base form.

The term “syntactic analysis” refers to a process of determining grammatical structure of a sentence, including relationships among words or phrases, such as dependency structures or phrase structures.

The term “phrase extraction” refers to a process of identifying relevant word groups or expressions, such as noun phrases or key phrases, from natural language character data.

The term “term or topic” refers to a linguistic unit or conceptual label obtained from natural language processing that represents a subject, concept, or theme associated with a user's interests.

The term “prompt sentence” refers to a structured text string that includes instructions, context, or constraints for a generative artificial intelligence model, generated automatically by inserting extracted terms or topics into a predetermined template or construction rule.

The term “predetermined sentence template” refers to a predefined pattern of text having one or more insertion positions for terms or topics, used to generate a prompt sentence in a consistent and machine-interpretable format.

The term “generative artificial intelligence model” refers to a machine learning model trained on a large dataset and configured to generate output data, such as text or structured information, in response to an input prompt sentence.

The term “information related to the user's interests and including a field that is unknown to the user” refers to generated information that is responsive to a user's expressed interests and additionally includes explanatory or exploratory content about related topics or domains that are likely unfamiliar to the user.

The term “post-processing” refers to operations applied to generated information after it is obtained from the generative artificial intelligence model, including at least one of summarization, segmentation, heading generation, and topic extraction.

The term “summarization” refers to a process of producing a shorter representation of generated information that preserves essential content and main points.

The term “segmentation” refers to a process of partitioning generated information into discrete sections, paragraphs, scenes, or logical units for improved readability or further processing.

The term “heading generation” refers to a process of creating titles, headings, or subheadings that represent main sections or topics in generated information.

The term “topic extraction” refers to a process of identifying principal themes, subjects, or conceptual categories within generated information.

The term “article data” refers to structured data representing a text-based content item, including at least a body of text and optionally headings, summaries, and metadata, formatted for presentation as an article to a user.

The term “video configuration data” refers to structured data representing a plan or outline for a video content item, including at least sections, scenes, narration text, or key points, and optionally metadata for video production or playback.

The term “data storage device” refers to a logical or physical storage system, such as a database or file system, that stores structured data, prompt sentences, and associated metadata in a retrievable manner.

The term “user identification information” refers to data that uniquely or pseudo-uniquely identifies a user or user account, such as a user ID, account ID, or similar identifier, used to associate generated content with the corresponding user.

The term “behavior history data” refers to log information representing user interactions with content presented on a terminal, including at least one of viewing events, selection events, operation events, and dwell time.

The term “viewing” refers to an action in which a user displays or reads content on a terminal screen for a measurable period.

The term “selection” refers to an action in which a user chooses a particular item, such as tapping or clicking on a displayed content entry or control element.

The term “operation” refers to an action in which a user interacts with user interface elements, such as scrolling, pressing buttons, or invoking commands related to the displayed content.

The term “dwell time” refers to a duration during which a user remains on a particular screen, view, or content item, used as an indication of engagement or interest.

The term “topic-specific weight information” refers to numerical or symbolic values assigned to respective topics associated with a user, representing strength, priority, or relevance of each topic based on behavior history data.

The term “subsequent prompt sentence” refers to a prompt sentence that is generated after at least one cycle of content generation and behavior logging, and that is modified or optimized based on updated topic-specific weight information.

The term “adaptively optimized for the generative artificial intelligence model” refers to a state in which the content or structure of prompt sentences is adjusted based on feedback data so as to improve the relevance, informativeness, or efficiency of outputs produced by the generative artificial intelligence model.

The term “plurality of types of prompt sentences” refers to multiple prompt sentences that differ from one another in at least one of length, level of detail, intended output format, or instruction content.

The term “summary data” refers to data representing condensed content derived from generated information, intended to provide a brief overview of the main points.

The term “mutually associated manner” refers to a storage relationship in which multiple data items, such as article data, summary data, and video configuration data, are stored with references or identifiers that indicate their association with one another and with a common generation context.

The term “list screen” refers to a user interface screen that presents multiple content items in a list or grid format, each item being represented by at least a title, summary, or key metadata.

The term “detail screen” refers to a user interface screen that presents detailed content of a single selected item, including at least the full article data or video configuration data and optionally associated metadata.

The term “condition under which the selected data has been generated” refers to generation-related information presented to the user, including at least the prompt sentence that was input to the generative artificial intelligence model and optionally information about user interests or topics used in constructing the prompt sentence.

According to one embodiment, a system for generating personalized content based on user interests includes a server, at least one terminal, a communication network, and a data storage device. The server includes at least one processor and at least one memory storing instructions. The terminal is, for example, a smartphone, tablet, or personal computer, and provides a user interface for receiving user interest information and presenting generated content.

The terminal provides a graphical user interface implemented, for example, using a mobile application framework such as a native mobile framework or a web browser environment. The terminal presents an input field in which the user inputs user interest information as natural language character data. The user inputs sentences such as “I am interested in space exploration and future Mars missions” or “I want to learn about sustainable fashion,” and the terminal transmits this data to the server over a network using a structured data format such as JavaScript Object Notation (JSON) and a secure transport protocol such as HTTPS.

The server receives the natural language character data and stores it temporarily in a memory. The server executes a natural language processing program implemented, for example, in a general-purpose programming language such as Python running on an operating system such as a Linux-based server operating system. The server may utilize existing natural language processing libraries such as a tokenization and part-of-speech tagging library (e.g., spaCy or an equivalent toolkit) or a natural language toolkit (e.g., NLTK or an equivalent toolkit) as components of the natural language processing program.

The server applies the natural language processing program to the received natural language character data. The server performs tokenization, morphological analysis, and syntactic analysis on the character data to obtain structured representations such as token sequences, part-of-speech tags, dependency trees, and named entities. The server performs phrase extraction to identify multi-word expressions such as noun phrases corresponding to user interests. From these structured representations, the server derives a set of terms or topics that represent the user's interests by filtering out function words and low-information tokens using stop-word lists and frequency thresholds.

The server converts the extracted terms or topics into a normalized form, such as converting them to lowercase, lemmatizing them, and mapping them to canonical topic identifiers stored in a topic dictionary. For example, the server may map the phrases “space exploration,” “future Mars missions,” and “space technology” to internal topic identifiers representing “space exploration” and “planetary exploration.” This normalization enables the server to treat semantically similar terms consistently and reduces sparsity in subsequent processing.

The server generates a prompt sentence by inserting the normalized terms or topics into a predetermined sentence template. The server stores one or more templates as parameterized strings that specify fixed instruction portions and placeholder positions for terms or topics. The server selects a template based on a target output type (e.g., long article, summary, or video configuration) and replaces placeholder positions with the extracted topics. For example, the server may generate a prompt sentence such as: “The user is interested in space exploration and future Mars missions. Please generate a detailed, easy-to-understand article explaining current space exploration technologies, planned Mars missions, and how these missions may change humanity's future. Use clear sections and practical examples.”

In another example, when the user interest relates to sustainable fashion, the server may generate a prompt sentence such as:
“The user is interested in sustainable fashion. Please generate an outline for a 10-minute educational video that introduces sustainable fashion, explains key eco-friendly materials, and gives practical shopping tips. Provide section titles and 2-3 bullet points for narration in each section.”

In another example, when the user interest relates to AI-generated music, the server may generate a prompt sentence such as:
“The user is interested in AI-generated music. Please generate an outline for a 10-minute educational video that explains how machine learning is used to create music. Include an introduction, 4-5 main sections covering model architectures, datasets, training methods, and ethical issues, and a concise conclusion. Provide suggested narration text for each section in clear, conversational language.”

The server transmits the prompt sentence to a generative AI model via an application programming interface. The generative AI model is implemented, for example, as a deep neural network model trained on a large-scale corpus of text. In one embodiment, the generative AI model is a transformer-based language model including an encoder-decoder or decoder-only architecture with multiple self-attention layers, feed-forward layers, and normalization layers. The model parameters include weight matrices for attention heads, projection layers, and feed-forward units, as well as bias vectors. The model has been pre-trained using unsupervised or self-supervised learning on large text datasets and fine-tuned, if desired, for instruction-following behavior.

The server provides the prompt sentence and model control parameters such as maximum output length, sampling temperature, and top-k or top-p sampling thresholds to the generative AI model. The generative AI model computes an output sequence by iteratively applying, for each token position, self-attention mechanisms over the previous tokens, computing contextualized embeddings, and applying a softmax function over the vocabulary to select or sample the next token according to the learned probability distribution. The model minimizes a loss function such as cross-entropy during pre-training, and weight parameters are updated via gradient-based optimization such as stochastic gradient descent or an adaptive variant. These internal operations differ from human manual writing processes and utilize high-dimensional vector computations and non-linear transformations that are specifically suited for computer hardware, such as vectorized instructions and parallel processing on graphics processing units.

The server receives the generated output sequence from the generative AI model as generated information. The server verifies that the generated information is non-empty and within predefined length bounds and checks for truncation or error markers. The server stores the raw generated information in a buffer for subsequent processing.

The server executes a post-processing module which may again utilize natural language processing libraries. The server performs summarization by computing, for example, sentence scores based on term frequency-inverse document frequency metrics or transformer-based embeddings, and selecting sentences that maximize content coverage while minimizing redundancy. The server performs segmentation by detecting topic shifts using cosine similarity between sentence embeddings or by using sequence labeling methods to segment the generated information into coherent sections or scenes. The server performs heading generation by extracting key phrases and ranking candidate headings using statistical scores or by applying a shorter prompt sentence to a smaller generative model that is specialized for title generation. The server performs topic extraction on the generated information to identify secondary topics that did not appear explicitly in the original user input.

The server structures the post-processed information into specific data structures for storage. For article data, the server constructs a record including fields such as a title string, a summary string, a list of section headings, a list of paragraphs, and associated topic identifiers. For video configuration data, the server constructs a record including fields such as a list of scene identifiers, for each scene a scene title, narration text, bullet points, and optional tags representing visual elements. These data structures are typically encoded in a structured format such as JSON or a similar object representation before being stored.

The server stores the structured data in a data storage device such as a distributed database or cloud-based storage service. The server associates each structured record with user identification information, the corresponding prompt sentence, timestamps, and topic identifiers. The server maintains indexes on user identification information and topic identifiers so that records can be efficiently retrieved for a given user or topic. This indexing and structuring improve retrieval latency and reduce the number of database operations required when the terminal requests content.

The terminal periodically or on request obtains structured data from the server. The terminal renders list screens for multiple records and detail screens for individual records. On the detail screen, the terminal displays not only the article data or video configuration data but also the corresponding prompt sentence or a paraphrased description of the generation condition. This transparency allows the user to understand how the content was produced and to refine their input interests.

The terminal monitors user behavior while the user interacts with the displayed content. The terminal records behavior history data such as viewing events, scroll positions, selection events, button presses (e.g., “show more like this”), and dwell time on particular sections. The terminal aggregates this behavior history data locally or transmits it incrementally to the server in compressed batches to reduce communication overhead.

The server receives the behavior history data and updates a user-specific topic weight vector stored in the data storage device. Each dimension of the topic weight vector corresponds to a topic identifier, and its value represents the strength of the user's interest in that topic. The server updates this vector using an algorithm such as an exponential moving average or a reinforcement learning-inspired update rule that increases weights for topics associated with content that the user views longer or selects more often, and decreases weights for topics associated with content that the user ignores or quickly leaves. By using a numeric vector representation, the server can compute topic similarity, perform fast retrieval of relevant topics, and adapt prompt construction efficiently.

The server uses the updated topic weight vector when generating subsequent prompt sentences. The server selects topics with higher weights, introduces adjacent topics derived from a topic ontology or co-occurrence matrix, and adjusts prompt templates to emphasize or de-emphasize specific instructions. For example, if the topic weight vector indicates that the user repeatedly engages with content about “reusable launch vehicles” within the broader “space exploration” domain, the server modifies subsequent prompt sentences to include explicit instructions to discuss reusable launch technologies and their impact, thereby tailoring generation to more specific interests while still exploring adjacent unknown fields.

This adaptive prompt construction improves the technical behavior of the generative AI model when executed on computer hardware. By converting unstructured user input into structured topic representations and weighted vectors, the server supplies the generative AI model with more precise and context-rich prompt sentences. This reduces the number of generation attempts required to obtain useful output, decreases token-level redundancy, and leads to shorter model runtimes and lower bandwidth usage. In addition, the structured association between user interest representations, prompt sentences, and generated outputs improves cache hit rates and enables partial reuse of previously generated content, further reducing processing load.

The server architecture, in one embodiment, includes separate modules for input handling, natural language processing, prompt generation, model interface, post-processing, storage management, and behavior analysis. Each module communicates via defined data structures and interfaces. For example, an input handling module converts HTTP requests to internal objects, a natural language processing module outputs term lists and dependency graphs, a prompt generation module outputs template-instantiated strings, and a behavior analysis module outputs updated topic weight vectors. This modular structure allows optimization of individual components, such as parallelizing natural language processing operations across multiple cores or offloading generative model inference to specialized hardware such as graphics processing units or tensor processing units.

The server improves computer technology in several ways. First, the server reduces unnecessary model invocations and network usage by determining, based on topic weights and existing stored content, when to reuse previously generated structured data instead of generating new content. Second, the server increases accuracy and relevance of generated content by providing the generative AI model with prompt sentences that incorporate structured linguistic features and behavior-derived topic weights, rather than raw user input. Third, the server improves data management by storing content, prompts, and behavioral profiles in closely linked data structures that support efficient indexing and retrieval. Fourth, the server increases processing efficiency by performing heavy text analysis and generation on the server side using optimized libraries and hardware, while the terminal focuses on lightweight rendering and interaction handling.

In another embodiment, the server may use alternative natural language processing components, such as a statistical topic model or a word embedding model to extract topics. The generative AI model may be replaced with another neural network architecture, such as a sequence-to-sequence model with attention or a recurrent neural network model, trained with a language modeling objective. The server may adjust training or fine-tuning of the generative AI model by using logs of prompt sentences and user engagement data as training examples, employing loss functions such as likelihood maximization combined with reward signals derived from engagement metrics. Weight updates may be performed using optimization algorithms such as Adam or RMSProp, and data augmentation techniques may include paraphrase generation or back-translation to increase robustness of the model to diverse prompt formulations.

In yet another embodiment, the server may control additional devices in a content production environment. For instance, based on video configuration data, the server may transmit structured scene and narration data to an editing workstation or to a video rendering engine that automatically composes preview videos. In such a case, the structured video configuration data directly influences hardware-level processing such as media encoding and frame rendering, thereby extending the technical effects to multimedia processing pipelines.

The terminal may also be implemented as a head-mounted display, an in-vehicle infotainment system, or another specialized interface device. In such cases, the structured data and prompt-based generation facilitate optimization of display layouts, adaptation to screen constraints, and reduction of user interaction steps. For example, the terminal may pre-fetch only summaries or low-resolution assets based on topic weights and user context, thereby reducing communication load and improving perceived responsiveness.

By combining natural language processing, structured topic representation, adaptive prompt sentence generation, and generative AI model control in a unified system, the server performs processing that is not a mere automation of human intellectual activity. Instead, the server employs computationally intensive, non-intuitive algorithms and data structures that are specifically tailored to digital execution and that improve the operation of computer systems, including faster response times, more efficient resource utilization, and improved accuracy and personalization of generated content.

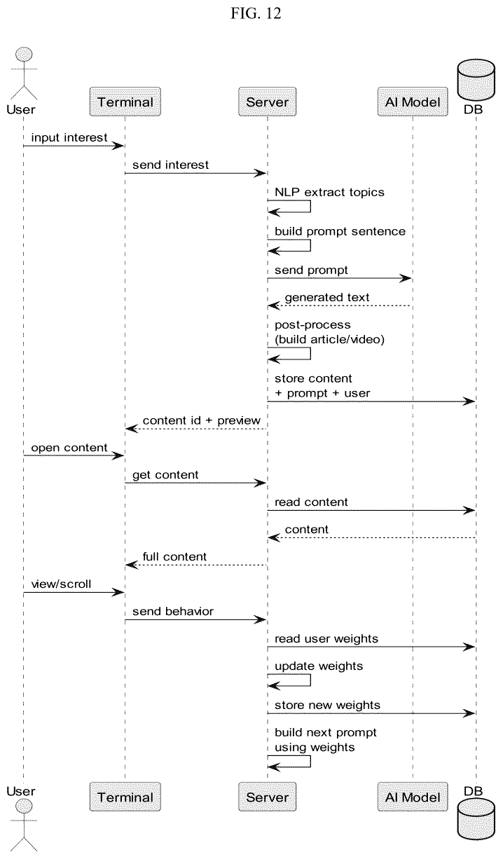

The following describes the processing flow using FIG. 12.

### Step 1

The user operates the terminal to launch an application and open an interest input screen.
Input: No prior data; the user is presented with an empty input field.
Output: Natural language character data entered by the user.

The user types a free-form sentence describing interests, such as “I am interested in space exploration and future Mars missions,” and confirms the input via a submit button. The terminal captures the exact character sequence, attaches a timestamp and a user identifier, and temporarily stores the data in local memory.

### Step 2

The terminal transmits the user interest information to the server via a network.
Input: User identifier, timestamp, and natural language character data.
Output: Structured request message received by the server.

The terminal serializes the user identifier, timestamp, and interest text into a structured message (e.g., JSON) and sends it over an HTTPS connection to a predefined server endpoint. The terminal waits for an acknowledgment or response code to ensure reliable delivery.

### Step 3

The server receives and parses the user interest information.
Input: Structured request message containing user identifier, timestamp, and interest text.
Output: Internal representation of user identifier, timestamp, and raw interest text stored in server memory.

The server accepts the incoming message at an application endpoint, verifies the message format, and extracts the user identifier and interest text into program variables. The server validates that the text is non-empty and within a permitted length range, logs the request with a request identifier, and stores the raw text in a buffer for further analysis.

### Step 4

The server performs natural language preprocessing on the interest text.
Input: Raw interest text.
Output: Token sequence, part-of-speech tags, and syntactic structure.

The server invokes a natural language processing program, for example using a tokenizer and part-of-speech tagger. The server splits the text into tokens, assigns part-of-speech tags to each token, and builds a dependency tree or parse tree representing sentence structure. The server writes the token list, tags, and parse tree to an internal data structure to be consumed by subsequent analysis steps.

### Step 5

The server extracts terms and topics representing the user's interests.
Input: Token sequence, part-of-speech tags, and syntactic structure.
Output: List of normalized terms or topic identifiers.

The server identifies candidate phrases such as noun phrases by traversing the syntactic structure, filters out stop words and low-information tokens, and computes frequency and relevance scores. The server normalizes the selected phrases by lowercasing and lemmatizing them and then maps them to internal topic identifiers using a topic dictionary or ontology. The server outputs a list of topic identifiers, for example [TOPIC_SPACE_EXPLORATION, TOPIC_MARS_MISSIONS].

### Step 6

The server constructs a prompt sentence for a generative AI model.
Input: List of normalized terms or topic identifiers.
Output: Prompt sentence as a single natural language string.

The server selects a sentence template according to a desired output type, such as an article or a video outline. The server retrieves human-readable labels for each topic identifier, inserts the labels into the template's placeholder positions, and concatenates fixed instruction text with the topic labels. For example, the server may generate the prompt sentence: “The user is interested in space exploration and future Mars missions. Please generate a detailed, easy-to-understand article explaining current space exploration technologies, planned Mars missions, and how these missions may change humanity's future. Use clear sections and practical examples.” The server stores this prompt sentence together with the topic identifiers for traceability.

### Step 7

The server prepares a model request for the generative AI model.
Input: Prompt sentence and model control parameters.
Output: Formatted model input data ready for transmission.

The server sets model parameters such as maximum token count, temperature, and sampling strategy, combines these parameters with the prompt sentence into a request object, and converts the object into the format required by the generative AI model interface. The server logs the size and key parameters of the request for monitoring and may batch multiple requests if supported.

### Step 8

The server sends the prompt sentence to the generative AI model and receives generated information.
Input: Model input data containing the prompt sentence and model parameters.
Output: Generated text representing information related to the user's interests.

The server transmits the model input data over a secure interface to the generative AI model, waits for the model to perform inference, and receives an output sequence of tokens. The generative AI model computes each output token by applying multi-layer attention and feed-forward transformations over internal embeddings; the server aggregates these tokens into a natural language string. The server checks for completion flags and verifies that the generated text satisfies minimum length or quality thresholds before passing it to post-processing.

### Step 9

The server performs post-processing on the generated information.
Input: Raw generated text from the generative AI model.
Output: Structured representation including sections, headings, and summary.

The server re-applies natural language processing to the generated text to detect sentence boundaries and paragraph boundaries. The server computes sentence importance scores using statistics or embedding similarity, selects key sentences to form a summary, and detects topic shifts to segment the text into logical sections. The server generates section headings by extracting or composing representative phrases. The resulting data structure includes a title, a summary, a list of section headings, and corresponding section bodies.

### Step 10

The server creates article data or video configuration data.
Input: Structured representation including sections, headings, and summary.
Output: Article data object and/or video configuration data object.

The server decides the content type based on the original request or system configuration. For article data, the server assembles the title, summary, section headings, and paragraphs into an article record. For video configuration data, the server converts sections to scenes, assigns scene identifiers, and associates each scene with narration text and bullet points derived from the sections. The server creates explicit fields for metadata such as topics, difficulty level, and estimated reading or viewing time.

### Step 11

The server stores the structured data and associated metadata.
Input: Article data or video configuration data, prompt sentence, user identifier, and topic identifiers.
Output: Persistent records in a data storage device.

The server constructs a storage document including user identifier, prompt sentence, structured content, topic identifiers, and timestamps. The server writes this document to a database or storage service, using keys or indexes that allow retrieval by user, by topic, or by time. The server records an internal content identifier assigned by the storage system and returns this identifier for use in subsequent retrievals.

### Step 12

The server returns a response to the terminal.
Input: Content identifier and optionally structured content.
Output: Response message containing content identifier and, in some cases, preview content.

The server creates a response object including the content identifier and a subset of fields such as title and summary for preview. The server serializes the response and transmits it over the network to the terminal. The server logs the completion of this request using the request identifier.

### Step 13

The terminal receives the response and updates its local state.
Input: Response message from the server containing content identifier and preview data.
Output: Updated terminal state and prepared display data.

The terminal parses the response, extracts the content identifier, title, and summary, and stores them in local memory or local storage. The terminal updates a list of available contents for the user and prepares user interface elements such as list entries and preview cards using the received data.

### Step 14

The terminal displays generated content to the user.
Input: Content identifier and structured content retrieved from the server or local cache.
Output: Visual representation of content on the terminal screen.

The terminal requests full content from the server or local cache when the user selects a preview. The terminal receives the structured article data or video configuration data, constructs a detail view, and renders sections, headings, and summary in a readable format. The terminal also displays the associated prompt sentence or a description of it, enabling the user to see the generation context.

### Step 15

The user interacts with the displayed content.
Input: Rendered content and user interface controls.
Output: User action events such as viewing, scrolling, selection, and feedback actions.

The user scrolls through sections, reads text, and may select controls such as “more like this” or “different perspective.” The terminal detects each interaction as an event, records attributes such as timestamps, scroll positions, and button identifiers, and accumulates these events in a behavior log.

### Step 16

The terminal sends behavior history data to the server.
Input: Behavior log containing user action events and content identifiers.
Output: Structured behavior history data received by the server.

The terminal groups recorded events by content identifier and time interval, compresses or filters events if necessary to reduce volume, and sends the grouped data to the server via an authenticated API call. The terminal may schedule this transmission periodically or trigger it after specific actions.

### Step 17

The server updates topic-specific weight information based on behavior history data.
Input: Behavior history data and current topic weight vector for the user.
Output: Updated topic weight vector stored in the data storage device.

The server maps each behavior event to associated topics using the stored relations between content identifiers and topic identifiers. The server computes engagement scores for each topic from measures such as dwell time, scroll depth, and selection frequency. The server updates the weight vector by applying an update rule, for example increasing weights for topics with high engagement and decreasing weights for topics with low engagement, normalized to maintain numerical stability. The updated vector is stored back to persistent storage.

### Step 18

The server generates subsequent prompt sentences using updated topic weights.
Input: Updated topic weight vector and current or new user interest text.
Output: New prompt sentence adapted to user behavior.

The server selects top-weighted topics and identifies adjacent topics using a topic graph or co-occurrence statistics. The server merges these topics with any newly extracted terms from fresh user input and chooses a template that emphasizes preferred topics and introduces related unknown topics. The server constructs a new prompt sentence by filling template placeholders with topic labels and explicit instructions tailored to the updated interest profile, thereby enhancing relevance and exploratory scope of subsequent generations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional information retrieval and recommendation systems, a processor typically matches user input directly against stored content or predefined categories and returns items that are closely aligned with explicitly expressed interests. Such systems often rely on keyword matching, simple similarity scoring, or fixed rule sets, and do not effectively identify or present information from domains that are unknown or unintentionally omitted by the user. As a result, the user is frequently confined to a narrow information neighborhood, and the computing system fails to guide the user toward emerging, cross-domain, or conceptually distant fields that could nevertheless be highly relevant.

Furthermore, conventional systems generally treat user interest analysis and content generation as separate, loosely coupled functions. User input is passed to a generative model in a relatively raw form, without structured concept extraction, vector-space reasoning, or explicit modeling of what constitutes an “unknown field” for a particular user. In such architectures, a generative model may produce generic explanations or redundant information that the user already knows, leading to inefficient use of computational resources and reduced utility of generated content.

Additionally, many existing systems do not maintain a fine-grained representation of user interaction history at the concept level, and therefore cannot algorithmically distinguish between concepts that are already familiar to the user and concepts that represent meaningful novelty. Without such differentiation, the system cannot systematically bias its generative process toward expanding the user's knowledge frontier while remaining anchored to the user's actual interests.

From a computer technology standpoint, these limitations manifest as suboptimal use of natural language processing resources, vector similarity search engines, and generative artificial intelligence models. The lack of an integrated pipeline that (i) extracts concept information from user input, (ii) maps the concept information into a vector space, (iii) identifies candidate related concepts via similarity search, (iv) filters those concepts against user history to isolate unknown domains, and (v) constructs prompt sentences that explicitly instruct a generative model to explain such unknown domains in relation to the user's interest, results in degraded system performance, unnecessary model invocations, and lower quality of generated outputs.

Accordingly, there is a need for an improved information processing system and method in which a processor systematically analyzes user interest input at the concept level, identifies related concepts corresponding to unknown fields by using vector-based similarity and user history, and generates prompt sentences that cause a generative artificial intelligence model to produce focused explanations connecting those unknown fields to the user's expressed interest. Such a system should improve the technical functioning of the underlying computing components by structurally guiding model usage, reducing irrelevant generation, and enabling more efficient and targeted expansion of the user's knowledge space.

The specific processing by the specific processing unit 290 of the data processing device 12 in Example 2 is realized by the following means.

The present invention provides a server comprising a processor and a memory storing instructions executable by the processor, wherein the processor is configured to receive, from a user terminal, character information indicating a user interest; perform normalization and linguistic analysis on the character information to extract concept information; convert the concept information into vector information by using a natural language processing technique; calculate candidate related concepts by performing a similarity search between the vector information corresponding to the concept information and vector information corresponding to a plurality of concepts stored in a similarity search storage device; select, from the candidate related concepts, a related concept corresponding to an unknown field with respect to the user on the basis of usage history information of the user; acquire explanation information regarding the related concept corresponding to the unknown field from a knowledge storage device; construct a prompt sentence by embedding the character information indicating the user interest, the related concept corresponding to the unknown field, and the explanation information into template information so that the prompt sentence includes a specific instruction text that causes a generative artificial intelligence model trained on a large-scale data set to output explanation information regarding the unknown field and information indicating a relationship between the unknown field and the user interest; input the prompt sentence and the explanation information into the generative artificial intelligence model; obtain generated information including the explanation information regarding the unknown field and the information indicating the relationship between the unknown field and the user interest; and generate output data including the generated information and transmit the output data to the user terminal so that the generated information is presented visually or audibly at the user terminal. This enables the computing system to technically improve the processing and utilization of generative artificial intelligence models by structurally guiding model input through vector-based concept analysis and user-history-aware unknown-field selection, thereby reducing irrelevant model output, enhancing the relevance and novelty of generated explanations, and more efficiently expanding the user's knowledge beyond explicitly expressed interests.

The term “processor” refers to one or more hardware computation units, such as a central processing unit or an accelerator, that execute instructions to perform the functions described in the system.

The term “user terminal” refers to an information processing apparatus, such as a portable device or a fixed display device, that communicates with the server, transmits user input, and presents generated information to a user.

The term “character information” refers to digital data representing symbols of a human language, including letters, numbers, punctuation, and spaces, which are input by the user to indicate an interest.

The term “user interest” refers to a subject, field, or topic that the user intends to explore or for which the user desires information, as expressed by the character information.

The term “normalization” refers to processing that converts input character information into a standardized representation, including operations such as case conversion, whitespace unification, and removal or unification of variant forms.

The term “linguistic analysis” refers to processing of character information using natural language techniques, including at least one of tokenization, morphological analysis, part-of-speech tagging, and entity recognition, to derive structured information.

The term “concept information” refers to an abstract representation of the meaning contained in the user interest, including extracted terms, entities, or semantic units obtained through linguistic analysis.

The term “natural language processing technique” refers to a computational method that analyzes or generates human language, including methods based on statistical models, rule-based systems, or machine learning models such as neural networks.

The term “vector information” refers to numerical data in a multi-dimensional space that encodes the semantic characteristics of concept information or other linguistic units for computation such as similarity measurement.

The term “candidate related concepts” refers to concepts distinct from but semantically associated with the user interest, which are obtained by comparing vector information for the user interest with vector information for a plurality of stored concepts.

The term “similarity search storage device” refers to a storage subsystem that holds vector information for multiple concepts and supports computation of similarity scores between vectors for the purpose of retrieving candidate related concepts.

The term “usage history information” refers to data representing a record of past interactions between the user and the system, including accessed topics, previously presented concepts, or prior queries associated with the user.

The term “unknown field” refers to a domain, topic, or concept that is related to the user interest but is determined, on the basis of usage history information, to be unfamiliar or not previously presented to the user.

The term “related concept corresponding to an unknown field” refers to a concept selected from the candidate related concepts that represents an unknown field with respect to the user while maintaining semantic relevance to the user interest.

The term “knowledge storage device” refers to a storage apparatus that holds structured or unstructured information, such as documents, records, or graph data, from which explanation information about concepts can be retrieved.

The term “explanation information” refers to descriptive content that provides a definition, overview, relation, or example regarding a concept, such as an unknown field, in a form suitable for presentation to a user.

The term “prompt sentence” refers to a text string or set of text strings that instruct a generative artificial intelligence model to perform a specific output task, including generation of explanation information.

The term “template information” refers to predefined structural data or text patterns including placeholders, which are filled with character information, concept information, and explanation information to construct the prompt sentence.

The term “instruction text” refers to a portion of the prompt sentence that explicitly indicates to the generative artificial intelligence model what type of output to produce, including required content, style, or focus.

The term “generative artificial intelligence model” refers to a machine learning model trained on a large-scale data set that, in response to input such as a prompt sentence, generates new data, including natural language text, based on learned parameters.

The term “large-scale data set” refers to a collection of training data comprising a substantial number of samples, such as documents or text sequences, used to train the generative artificial intelligence model.

The term “generated information” refers to output produced by the generative artificial intelligence model, including explanation information regarding an unknown field and information indicating a relationship between the unknown field and the user interest.

The term “output data” refers to data generated by the processor that encapsulates the generated information in a format suitable for transmission to and rendering by the user terminal.

The term “presented visually or audibly” refers to the form in which the generated information is output at the user terminal, including at least one of display on a screen and reproduction by a sound output device.

In one embodiment, a server includes a processor and a memory storing instructions that, when executed by the processor, cause the server to cooperate with a terminal operated by a user in order to expand the user's knowledge beyond an explicitly expressed interest. The server is implemented on a hardware platform such as a rack-mounted computer or a virtual machine in a data center, including at least one multi-core central processing unit, a main memory, a non-volatile storage device, and optionally one or more graphics processing units. The server executes an operating system such as a general-purpose server operating system, and runs application software including a web server, an application framework, a natural language processing library, a similarity search engine, a database management system, and a generative AI inference engine.

The terminal is implemented as a portable or stationary information processing device, such as a smartphone, a tablet, or a personal computer. The terminal includes a display unit such as a liquid crystal display or an organic light-emitting diode panel, an input unit such as a touch panel or keyboard, a communication interface such as a wireless or wired network interface, and a processor executing a browser or a dedicated application. The terminal sends user input to the server and presents generated information received from the server to the user in a visual or auditory form.

The user operates the terminal to access a user interface provided by the server. The user interface is rendered, for example, as a web page in a browser or as a screen in a native application. The user inputs character information indicating a user interest, such as a short phrase or sentence. For instance, the user may type “I want to know the latest trends in AI technology” or “Explain new fields related to artificial intelligence” into a text input field displayed on the terminal.

The server receives the character information via a communication interface using a protocol such as HTTP over a transport protocol. The server passes the received character information to a natural language processing module implemented using a software library such as a statistical tokenization library or a neural network-based language processing framework. The server performs normalization on the character information, including converting alphabetic characters to a uniform case, normalizing whitespace, and unifying variant forms of symbols. The server then performs linguistic analysis, including tokenization and morphological analysis, to segment the text into units such as words or morphemes and to annotate part-of-speech information. The server optionally applies named entity recognition or custom rule-based recognition to identify domain-specific expressions within the user interest.

The server converts the extracted concept information into vector information using a language representation model. In one embodiment, the server uses a transformer-based encoder network having multiple self-attention layers, feed-forward layers, and layer normalization components. The model receives tokenized text, converts tokens into embeddings via an embedding matrix, processes the embeddings through stacked attention blocks, and produces a fixed-length vector representing the semantics of the user interest. The server stores the resulting vector in a transient memory area associated with the current request.

The server maintains a similarity search storage device implemented using a vector index library. The storage device holds vector representations for a plurality of concepts, where each concept may correspond to a technical field, topic, or domain entity. These vectors are pre-computed using the same or a compatible encoder model and are stored along with concept identifiers and metadata. The server computes similarity scores (for example, cosine similarity or inner product) between the vector for the user interest and the stored vectors for the plurality of concepts. By executing a nearest-neighbor search algorithm such as approximate nearest neighbor search, the server efficiently retrieves a set of candidate related concepts with the highest similarity scores.

The server accesses usage history information stored in a database. The usage history information is represented by records associating a user identifier with concept identifiers, timestamps, interaction types, and possibly frequency counts or relevance scores. The server compares the identifiers of the candidate related concepts with the concept identifiers already present in the usage history information. The server selects, from among the candidate related concepts, at least one related concept that has not yet been logged as presented or requested for that user, or that is associated with a low familiarity score, and treats such a concept as corresponding to an unknown field for that user. For example, when the user interest is represented by “AI technology”, the server may identify “quantum computing” or “neuromorphic computing” as related concepts that are absent from the user's history and designate these concepts as unknown fields.

The server acquires explanation information for the selected related concept from a knowledge storage device. The knowledge storage device may be implemented as a relational database, a document store, or a graph store. The server issues a query using the concept identifier or concept label as a key and retrieves descriptive texts, definitions, keyword lists, or relationships between the related concept and other concepts. The server normalizes and structures the retrieved explanation information, for example by extracting a short summary and a longer detailed description for each related concept.

The server maintains template information that defines a structure for a prompt sentence for a generative AI model. The template information includes placeholders for the user interest, the related concept corresponding to the unknown field, and the explanation information retrieved from the knowledge storage device, as well as instruction text describing the desired output from the generative AI model. The server combines the user-specific and concept-specific data with the template information to construct a concrete prompt sentence. In one example, the server generates a prompt sentence such as:
“The user is interested in ‘AI technology’. Suggest and explain related but less familiar fields such as ‘quantum computing’ and ‘neuromorphic computing’ that could expand the user's knowledge, and describe why each field is relevant to AI.”

In another example, the server generates a prompt sentence such as:
“User query: ‘I want to know the latest trends in AI technology.’ Based on this interest, propose emerging or less known domains that are closely related to AI, and describe how they influence or extend AI, using clear and concise language.”

In yet another example, for a follow-up request, the server generates a prompt sentence such as:
“The user has already seen an overview of quantum computing as related to AI technology. The user now asks for more detail. Explain in more depth how quantum computing can impact AI algorithms and applications, including at least two concrete examples.”

The server inputs the constructed prompt sentence, and optionally the structured explanation information, into a generative AI model. In one embodiment, the generative AI model is implemented as a large-scale transformer-based decoder network trained on a large-scale text corpus. The network includes an embedding layer, a plurality of self-attention layers with multi-head attention mechanisms, residual connections, normalization layers, and output projection layers that produce token probabilities over a vocabulary.

The server runs the generative AI model on a processing unit optimized for matrix operations, such as a graphics processing unit. The server sets generation parameters including a maximum token length, a temperature parameter controlling randomness, and a sampling strategy such as top-k or nucleus sampling. The generative AI model receives the prompt sentence as a sequence of token identifiers and processes the sequence through its stacked decoder layers to compute a probability distribution for each subsequent token. By iteratively sampling or selecting tokens according to the distribution, the model generates an output text that includes explanation information regarding the unknown field and information indicating the relationship between the unknown field and the user interest.

During training of such a generative AI model, a training system minimizes an error function, for example a cross-entropy loss between predicted token distributions and ground truth tokens over many sequences. The system updates model parameters, such as weight matrices in attention and feed-forward layers, using an optimization algorithm such as stochastic gradient descent or Adam. Training data may be augmented by rewriting or paraphrasing texts, masking tokens, or adding synthetic prompts to improve robustness. The trained model thus learns to generate coherent, context-appropriate explanations when provided with prompt sentences that include explicit instruction text.

The server optionally post-processes the generated information by segmenting the output into sections for each unknown field and summarizing long passages. The server may use additional natural language processing algorithms, such as sentence segmentation and keyword extraction, to structure the output into a hierarchical data representation containing titles, summaries, and detailed explanations. The server then encapsulates this structured representation into output data for delivery to the terminal. The server uses a serialization format supported by the application framework and attaches metadata such as language codes, display hints, and identifiers linking the generated explanations back to concept identifiers.

The terminal receives the output data and parses it using a runtime environment such as a browser engine or an application framework runtime. The terminal renders the generated information on the display, arranging unknown fields into clearly separated sections. For example, the terminal displays headings such as “Quantum Computing” and “Neuromorphic Computing”, along with short summaries and collapsible detailed explanations. The terminal may also initiate text-to-speech processing using a local speech synthesis engine to output the explanations through a speaker, providing auditory presentation for accessibility or hands-free usage.

The server thereby implements a specific technical pipeline that differs from conventional systems that merely forward raw user queries to a generative AI model. By performing concept-level analysis, vector-space similarity search, user-history-based unknown field selection, and template-based prompt sentence construction before invocation of the generative AI model, the server reduces the search space of possible outputs and supplies the model with structured, high-value context. This design causes the model to focus its computational resources on generating explanations that are both novel and relevant to the user, which can reduce unnecessary token generation and overall computation cost on the accelerator hardware.

The server improves processing speed and responsiveness by reusing pre-computed vector representations in the similarity search storage device and by limiting the number of candidate related concepts handled in each request. The server improves the accuracy and usefulness of generated information by excluding concepts that are already present in the usage history information and by constraining the generative AI model through explicit instruction text in the prompt sentence. Because the system identifies unknown fields in a vector space and binds them to concrete knowledge entries before prompting the model, the generated explanations are more likely to be specific, technically coherent, and aligned with stored knowledge, thereby reducing error rates associated with unsupported or irrelevant outputs.

The server also improves data management by maintaining consistent mappings between concept identifiers, vector representations, and usage history entries. This structured mapping allows efficient updates and deletions of concepts, controlled expansion of the knowledge space, and incremental retraining or fine-tuning of models using selected subsets of data. The architecture supports alternative embodiments in which different encoder models, similarity metrics, or storage formats are used, while preserving the same fundamental pipeline of concept extraction, similarity-based candidate retrieval, history-aware unknown field selection, and prompt engineering.

In another embodiment, the server uses a different neural network architecture for the encoder or similarity step, such as a convolutional text encoder or a recurrent network, while maintaining the same integration with the generative AI model. In still another embodiment, the server uses a rule-based filter in addition to the similarity search to exclude concepts that are outside predefined domains or that do not satisfy reliability criteria. The server may also adapt the structure of the prompt sentence based on device capabilities of the terminal, for example requesting shorter explanations for small-screen devices or summarized content when network bandwidth is constrained.

The user benefits from this configuration because the terminal presents concise, high-relevance explanations about unknown fields that the user did not explicitly request, while the underlying server and models operate more efficiently and accurately due to the described technical pipeline. The described integration of vector-based concept analysis, user-history-based selection, and structured prompt sentence construction constitutes an improvement to computer technology itself, rather than a mere automation of manual reading or recommendation tasks, by optimizing the internal data structures, processing flow, and resource usage of the server and its generative AI components.

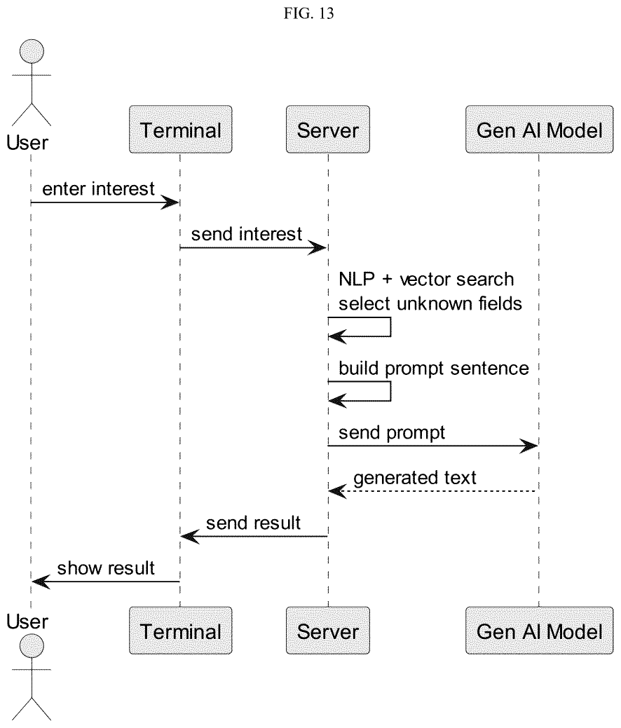

The following describes the processing flow using FIG. 13.

### Step 1

The terminal displays a user interface and acquires user input.

The terminal loads a screen implemented in a browser or native application and renders a text input field and a send control. The user inputs character information indicating a user interest, such as “I want to know the latest trends in AI technology”, and activates the send control. As input, the terminal receives raw keystroke or touch events and converts them into a character string. The terminal then constructs a request message that includes the character string and metadata such as a user identifier and a timestamp as output for transmission.

### Step 2

The terminal transmits the request message to the server.

The terminal uses a communication interface to open a network connection to the server and sends the request message using a protocol such as HTTPS. As input, the terminal uses the constructed request message from Step 1 and a destination address of the server. The terminal encapsulates the character information in a request body and sets appropriate headers, thereby producing a formatted network packet as output and placing it on a transport channel toward the server.

### Step 3

The server receives the request and parses the character information.

The server accepts the network packet through a communication interface and passes it to a web server component and an application framework. As input, the server receives the serialized request message containing the character information and metadata. The server deserializes the request, checks protocol headers, and extracts the character string representing the user interest. The server outputs a normalized internal representation of the request, including the user identifier, the plain text of the interest, and a request identifier.

### Step 4

The server performs normalization and linguistic analysis to obtain concept information.

The server takes, as input, the extracted character string and feeds it to a natural language processing module. The server applies normalization operations such as converting all letters to a uniform case, trimming leading and trailing spaces, and replacing multiple spaces with a single space. The server then performs tokenization and morphological analysis to segment the text into tokens and assign part-of-speech tags. The server may also apply named entity recognition or domain-specific pattern rules. Through these data processing operations, the server converts the normalized text into a structured data object containing tokens, parts of speech, and detected entities, and outputs this object as concept information.

### Step 5

The server converts the concept information into vector information.

The server uses, as input, the structured concept information from Step 4 and a language representation model stored in memory. The server embeds tokens into numerical vectors, aggregates token embeddings using a transformer-based encoder or similar architecture, and computes a single or multiple semantic vectors representing the user interest. This involves matrix multiplications, attention weight computations, and non-linear activations. The server outputs vector information, such as one or more floating-point arrays associated with concept identifiers, and stores them temporarily in working memory.

### Step 6

The server performs similarity search to obtain candidate related concepts.

The server uses, as input, the vector information from Step 5 and a similarity search storage device that holds vectors for a plurality of registered concepts. The server executes a nearest-neighbor search algorithm, computing similarity scores such as cosine similarity between the user-interest vector and each stored concept vector, or between the user-interest vector and clusters in an index structure. The server selects the top-scoring concepts as candidate related concepts and outputs a ranked list of concept identifiers and similarity scores.

### Step 7

The server filters candidate related concepts using usage history information to identify unknown fields.

The server retrieves, as input, the ranked list of candidate related concepts from Step 6 and usage history information stored in a database for the corresponding user. The server compares concept identifiers in the candidate list with identifiers recorded as previously presented or frequently accessed in the history. The server performs data operations such as set difference and threshold comparison on familiarity scores. Based on this computation, the server removes concepts that are already familiar and selects remaining concepts as related concepts corresponding to unknown fields. The server outputs a filtered list of one or more unknown-field concepts with associated metadata.

### Step 8

The server acquires explanation information for each unknown-field concept.

The server uses, as input, the filtered list of unknown-field concepts from Step 7 and a knowledge storage device containing descriptive records. The server issues queries keyed by concept identifiers or labels and retrieves explanation texts, definitions, relationships, and example data related to each concept. The server then processes the retrieved data by trimming, segmenting, or summarizing long texts. The server outputs a structured set of explanation information, for example a mapping from each unknown-field concept to a short summary and an optional detailed description.

### Step 9

The server constructs a prompt sentence using template information.

The server uses, as input, the original character string indicating the user interest from Step 4, the list of unknown-field concepts from Step 7, and the explanation information from Step 8, together with stored template information. The server fills placeholders in the template with these values, and appends instruction text specifying the required output structure, such as asking for relationships to the user interest and concise explanations. As part of this text processing, the server concatenates strings and inserts delimiters to form a coherent prompt sentence. The server outputs a completed prompt sentence for use by the generative AI model. For example, the server may output a prompt sentence such as: “The user is interested in ‘AI technology’. Suggest and explain related but less familiar fields such as ‘quantum computing’ and ‘neuromorphic computing’ that could expand the user's knowledge, and describe why each field is relevant to AI.”

### Step 10

The server invokes the generative AI model with the prompt sentence.

The server takes, as input, the constructed prompt sentence from Step 9 and optionally the structured explanation information from Step 8. The server tokenizes the prompt sentence according to the vocabulary of the generative AI model, converts tokens to numerical identifiers, and forwards the token sequence to a generative AI model hosted on the same machine or an attached accelerator. The server sets generation parameters such as maximum length and randomness. The generative AI model executes internal neural network computations over multiple layers to predict subsequent tokens conditioned on the prompt, and the server receives, as output, a sequence of generated tokens. The server decodes the tokens into a text string representing generated information about the unknown fields and their relationship to the user interest.

### Step 11

The server post-processes the generated information and prepares output data.

The server uses, as input, the generated text from Step 10 and the previously known list of unknown-field concepts. The server segments the text into sections by detecting headings or concept names, and may apply additional linguistic processing to extract summaries or key sentences. The server then constructs a structured output object that associates each unknown-field concept with a title, a summary, and a detailed explanation. The server serializes this object into a response format and adds metadata such as language information and layout suggestions. The server outputs a final response message ready for transmission to the terminal.

### Step 12

The server transmits the response message to the terminal.

The server uses, as input, the serialized response message from Step 11 and connection information for the terminal obtained from the original request. The server sets appropriate protocol headers, including content type and status code, and writes the response message to the network socket associated with the terminal session. The server thereby outputs one or more network packets containing the generated information for delivery to the terminal.

### Step 13

The terminal receives the response message and renders the generated information.

The terminal accepts, as input, the network packets sent by the server and reassembles them into the response message. The terminal parses the response payload and obtains the structured description of unknown-field concepts and their explanations. Based on this structured data, the terminal updates the user interface, generating visual components such as headings, summary texts, and expand/collapse sections. The terminal may also transfer the explanation text to a text-to-speech engine to produce audio output. The terminal outputs the rendered content on the display and, if applicable, through a speaker, thereby presenting the generated information to the user.

### Step 14

The user reviews the generated information and optionally issues follow-up queries.

The user views, as input, the visual presentation on the terminal or listens to the audio explanation. The user interprets the sections labeled with unknown-field concepts, such as “quantum computing” or “neuromorphic computing”, and reads the accompanying explanations describing their relevance to the original interest. If the user desires additional detail or clarification, the user inputs new character information such as “Explain more about how quantum computing affects AI” through the same interface. This new character information becomes output from the user and new input to the terminal, which repeats the sequence beginning at Step 1 for iterative knowledge expansion.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information recommendation systems and content delivery systems suffer from several technical limitations in how they generate and control machine-generated information. First, typical systems treat a generative AI model as a passive text generator: they forward user input directly to the model with minimal preprocessing, without constructing optimized prompt sentences or leveraging structured user behavior data. As a result, the output of the generative AI model is often poorly targeted, redundant with information the user has already consumed, and difficult to adapt systematically, which degrades the technical effectiveness of the recommendation pipeline.

Second, known systems do not integrate the user's long-term behavior history and feedback in a closed technical loop that automatically refines both the user interest model and the prompt sentence construction rules. Behavioral logs such as viewing time, selection frequency, and explicit evaluations are usually stored or used for simple scoring, but are not systematically fed back to re-parameterize the way prompts are formed and how the generative AI model is invoked. This lack of adaptive prompt optimization leads to inefficient use of computational resources on the generative AI model side and limits the system's ability to converge to high-quality, user-specific outputs.

Third, existing architectures generally fail to incorporate a robust, machine-implemented emotion analysis mechanism that influences both the content and the timing of information generation and delivery. Many systems either ignore the user's emotional state entirely, or treat it as an auxiliary display parameter. They do not algorithmically adjust the content's level of detail, tone, and presentation timing on the basis of a classified emotional state derived from multimodal inputs such as text, images, and audio. Consequently, even if the same generative AI model is used, the human-machine interface layer remains static and cannot exploit the model's flexibility to deliver context-appropriate information.

Fourth, in many implementations the recommendation and generation processes are decoupled. A collaborative-filtering or classification engine may select items, while a separate text generator produces generic explanations. The system does not treat the prompt sentence as a programmable control surface that encapsulates both the selection logic (known vs. unknown fields) and the presentation policy (tone, length, depth). This architectural separation makes it difficult to systematically evolve the behavior of the system based on observed correlations between prompt patterns and user responses, thereby limiting the improvement of the underlying computer technology.

Therefore, there is a need for a computer-implemented system that (i) constructs and updates prompt sentences in a structured manner by using natural language processing technology and statistical learning technology over user interest data and behavior history, (ii) uses a trained generative information processing model in a feedback loop where prompt construction rules are automatically adapted based on logged user responses, and (iii) integrates an emotion analysis pipeline to dynamically adjust content, depth, tone, and timing of generated information. Such a system would technically improve the way computing resources are used to generate, filter, and deliver machine-generated information, and would enhance the precision, relevance, and responsiveness of an AI-based recommendation engine as a whole.

The specific processing by the specific processing unit 290 of the data processing device 12 in Application Example 2 is realized by the following means.

The present invention provides a server comprising a processor configured to acquire information regarding a user interest, analyze the information regarding the user interest together with behavior history information of the user by using natural language processing technology and statistical learning technology so as to specify a subject of interest of the user and a related field and to construct a prompt sentence for instructing generation of information in a related field not yet accessed by the user, input the constructed prompt sentence into a trained generative information processing model so as to cause the generative information processing model to generate text data including information related to the user interest and not yet accessed by the user, analyze an emotional state of the user on a basis of at least one of text input of the user, the behavior history information of the user, image information of the user, and sound information of the user, adjust at least one of content, level of detail, tone, and presentation timing of the prompt sentence and the generated text data in accordance with the emotional state, transmit the generated text data and information regarding related content not yet viewed or browsed by the user to a terminal device of the user so as to present the generated text data and the information regarding the related content to the user and to acquire feedback information regarding selection, browsing, and evaluation performed by the user, and update a user interest model and rules for constructing the prompt sentence by using the natural language processing technology and the statistical learning technology on a basis of the feedback information and the behavior history information so as to automatically improve content of a subsequent prompt sentence and subsequently generated information. This enables a computer system to technically optimize the interaction with a generative AI model by dynamically constructing and refining prompt sentences and delivery parameters based on learned user interest models, multimodal emotion analysis, and feedback-driven adaptation, thereby improving the efficiency, relevance, and controllability of machine-generated information within the underlying computing architecture.

The term “processor” refers to one or more hardware-based computing units, such as a central processing unit or a graphics processing unit, and any associated control circuitry configured to execute instructions that implement the functions described herein.

The term “user interest” refers to information indicating a preference, curiosity, or focus of a user toward at least one topic, domain, or category, the information being expressed for example as natural language text, selected keywords, or implicit behavior-derived signals.

The term “behavior history information” refers to machine-readable data representing past actions of a user within a system, including at least one of viewing records, selection operations, browsing time, interaction frequency, evaluation results, and similar usage logs.

The term “natural language processing technology” refers to a set of computer-implemented techniques for analyzing, interpreting, and generating human language, including at least one of tokenization, part-of-speech tagging, syntactic parsing, semantic analysis, entity recognition, topic extraction, and text embedding.

The term “statistical learning technology” refers to a set of computer-implemented methods that learn parameter values or models from data, including at least one of supervised learning, unsupervised learning, reinforcement learning, regression, classification, clustering, and matrix factorization.

The term “subject of interest” refers to a topic, concept, or category identified by the system as being of particular relevance to a user, the topic, concept, or category being derived from user interest information and behavior history information.

The term “related field” refers to a topic, domain, or category that is inferred by the system to have a semantic or behavioral relationship with a subject of interest of a user, including fields that the user has not yet accessed.

The term “prompt sentence” refers to a machine-generated or machine-assembled natural language instruction sequence that is provided as input to a generative information processing model in order to control or guide the generation of output information.

The term “generative information processing model” refers to a parameterized computational model trained on data to produce new information in response to input, including at least a generative AI model that generates text data based on a prompt sentence.

The term “text data” refers to machine-readable sequences of characters representing natural language content, including at least one of explanations, summaries, recommendations, descriptions, and any other linguistic output generated by a generative information processing model.

The term “emotional state” refers to a condition of a user characterized by one or more emotion categories, such as curiosity, anxiety, excitement, relaxation, concentration, or distraction, the condition being estimated by analysis of at least one of user text, behavior history information, image information, and sound information.

The term “image information” refers to digital data representing visual content associated with a user, including at least still images and video frames captured by an imaging device and suitable for computer-based analysis.

The term “sound information” refers to digital data representing audio content associated with a user, including at least voice signals captured by a microphone and suitable for computer-based analysis.

The term “content” refers to machine-represented information or media items that can be presented to a user, including at least text, images, audio, video, documents, and links to such items.

The term “presentation timing” refers to a point in time or a time interval determined by the system at which generated information or content is delivered or displayed to a user.

The term “terminal device” refers to any end-user device capable of communicating with a server and presenting information to a user, including at least portable communication devices, wearable devices, and general-purpose computing devices.

The term “feedback information” refers to data indicating a reaction of a user to presented information or content, including at least selection operations, browsing time, completion status, rating values, explicit evaluations, and free-text comments.

The term “user interest model” refers to a data structure and associated parameters maintained by the system to represent and predict preferences or interests of a user over topics, domains, or content categories, the data structure being updated based on behavior history information and feedback information.

The term “rules for constructing the prompt sentence” refers to machine-readable definitions, templates, or algorithms that specify how to assemble or select components of a prompt sentence, including at least selection of instruction type, insertion of topics, specification of tone, and determination of target length.

The term “unknown field exploration” refers to a mode of operation in which a prompt sentence and subsequent information generation are configured to introduce a user to topics or domains that the user has not yet accessed but that are related to existing interests.

The term “known field deep investigation” refers to a mode of operation in which a prompt sentence and subsequent information generation are configured to provide more detailed, advanced, or comprehensive information within a field already known to be of interest to a user.

The term “mood improvement” refers to a mode of operation in which a prompt sentence and subsequent information generation are configured to provide information or content that is adapted to positively influence or support the user's emotional state.

The term “template” refers to a structured representation for a prompt sentence that includes fixed text segments and variable slots, the variable slots being filled with context-specific data such as a subject of interest, a related field, a recommended tone, or a target amount of information.

The term “expression format of the prompt sentence” refers to a stylistic and structural configuration of a prompt sentence, including at least word choice, sentence ordering, level of explicitness of instructions, and layout conventions.

The term “instruction content of the prompt sentence” refers to substantive directives contained in a prompt sentence that guide a generative information processing model, including at least task definitions, constraints, desired output style, and target topics.

The term “correlation” refers to a statistical relationship or association estimated by the system between at least one feature of a prompt sentence and at least one measure of a user response, such as browsing time, selection frequency, or evaluation information.

In one embodiment, a server includes a processor, a main memory, a non-volatile storage unit, and a network interface coupled via a system bus. The server executes an operating system and an application program that implements the functions described herein. The server communicates with one or more terminals through a communication network such as the Internet, and each terminal includes at least a display, an input interface, and, in some embodiments, a camera and a microphone.

The server stores in the non-volatile storage unit program modules including a natural language processing module, a statistical learning module, a generative AI interaction module, an emotion analysis module, a prompt construction module, a user interest modeling module, a content selection module, and a logging module. The server loads these modules into the main memory and executes them on the processor.

The server, in the natural language processing module, uses a language processing library such as a generic tokenization and parsing library to perform tokenization, part-of-speech tagging, lemmatization, and entity recognition on user interest text. The server converts character sequences into token identifiers, attaches part-of-speech tags, and constructs dependency trees. The server then maps the resulting tokens and entities into a vector representation space by using a contextual embedding model implemented as a multi-layer bidirectional sequence model, for example a multi-layer recurrent neural network or a transformer encoder network.

The server, in the user interest modeling module, stores behavior history information for each user in a data structure such as a user-profile table and an interaction-event table. Each record in the user-profile table links a user identifier to one or more subject-of-interest identifiers and learned parameter vectors. Each record in the interaction-event table stores at least a content identifier, a timestamp, a content type, and numerical features such as viewing time, scroll depth, selection count, and explicit evaluation scores.

The server, in the statistical learning module, transforms the behavior history information into feature vectors. The server encodes categorical variables such as content category and genre into one-hot vectors or low-dimensional embeddings, normalizes numerical variables such as viewing time and rating values, and concatenates these values into fixed-length feature vectors. The server then uses a learning algorithm such as mini-batch stochastic gradient descent applied to a neural network, a matrix factorization model, or a gradient-boosted decision tree model to learn parameters that map the feature vectors to predicted interest scores for topics and content items.

The server implements the neural network in the statistical learning module as a multilayer perceptron with input, hidden, and output layers. The input layer receives the concatenated feature vector. The hidden layers apply affine transformations and nonlinear activation functions such as rectified linear units. The output layer produces real-valued interest scores for a finite set of topics. The server defines an error function such as mean squared error or cross-entropy between predicted scores and supervised labels derived from behavior history (for example, high labels for completed views and positive evaluations, low labels for short views and negative evaluations). The server computes gradients of the error function with respect to the network parameters and updates the parameters using a weight update rule such as Adam or momentum-based stochastic gradient descent.

The server, in the user interest modeling module, aggregates the trained parameters into a user interest model that represents for each user a latent preference vector over topics. The server periodically retrains or incrementally updates this model when new behavior history information is added to the interaction-event table. By representing the user interest as a compact latent vector, the server reduces the dimensionality of the data and enables faster subsequent computations for topic prediction and prompt construction.

The server, in the prompt construction module, receives the current user interest information and the latest state of the user interest model. The server selects a subject of interest and one or more related fields by computing similarity scores between the user's latent preference vector and topic vectors stored in a topic database. The server then selects one of several prompt templates stored in a template repository. Each template is an abstract pattern that specifies an instruction type, a tone, a target length, and the relative emphasis among known fields, unknown related fields, and emotional adaptation.

The server selects the template by applying a rule set that considers at least the user interest model and the emotional state. For example, the server chooses an “unknown field exploration” template when the user has a strong interest in a domain but low exposure to neighboring domains, and chooses a “known field deep investigation” template when the user has extensive interaction history with a domain and requests more detailed information.

The server then fills variable slots in the selected template with context data, thereby constructing a specific prompt sentence in natural language. The context data includes at least the subject of interest, related fields, a recommended tone descriptor, and a target amount of information expressed as an approximate number of items or paragraphs. Example prompt sentences constructed by the server include: “User is interested in ‘SF movies’, especially cyberpunk and dystopian themes. Based on this, recommend 10 lesser-known SF films the user is unlikely to have seen, and explain in 2-3 sentences why each film matches these interests.” “Based on the user's strong interest in both technology and health topics, suggest 5 up-to-date news articles or themes at the intersection of these fields, and provide concise, engaging summaries (3-4 sentences each) explaining why each topic is relevant to them.” “The user is anxious about environmental problems but wants to learn more. Using a calm and reassuring tone, generate an article that explains current environmental technologies and emphasizes concrete success stories and solutions.” “The user entered ‘AI technology’ and is highly curious. Explain quantum computing and its relationship with AI in detail, including basic concepts, current research trends, and how it connects to practical applications, in an engaging style suitable for a technically inclined non-expert.” “The user is relaxed and wants entertainment recommendations. Recommend several movies that match their past preferences, and briefly justify each choice.”

The server, in the generative AI interaction module, sends the constructed prompt sentence to a generative AI model hosted on a computing platform. The generative AI model is implemented as a large-scale neural network having, for example, dozens of transformer layers, each layer including multi-head self-attention sublayers and position-wise feed-forward sublayers. The generative AI model receives the prompt sentence as a sequence of token identifiers and computes contextual token embeddings by iteratively applying matrix multiplications, attention score computations, softmax operations, and nonlinear transformations.

The generative AI model, in response to the prompt sentence, outputs text data in the form of a token sequence. The server receives the token sequence from the generative AI model and decodes it into a character string. The server optionally segments the character string into structured units such as item titles and explanations by identifying delimiters such as line breaks and numbering patterns. The server thereby obtains machine-readable recommendation entries for use in later modules.

The server, in the emotion analysis module, classifies the emotional state of the user. The server, in a text-based embodiment, analyzes user-generated text such as queries and comments by applying a sentiment classifier implemented as a neural network or a lexicon-based model. The server transforms the text into embeddings and feeds them into a classifier layer that outputs probabilities over emotion categories such as curiosity, anxiety, excitement, relaxation, concentration, and distraction.

In a multimodal embodiment, the terminal captures images of the user's face by using the camera and captures voice signals by using the microphone, then transmits encoded image frames and audio segments to the server. The server extracts visual features via a convolutional neural network applied to the image frames, and extracts acoustic features via a recurrent or transformer-based network applied to the audio segments. The server combines these visual and acoustic feature vectors and feeds them into a classification network that outputs the emotional state. The server stores the emotional state as a time-stamped record in an emotion-state table associated with the user identifier.

The server uses the estimated emotional state to adjust at least one of the content, level of detail, tone, and presentation timing of the generated text data and of subsequent prompt sentences. For example, when the emotional state indicates anxiety, the server modifies the prompt template to request a reassuring tone and to emphasize solution-oriented content. When the emotional state indicates high curiosity, the server selects templates with higher target length and increased technical depth. When the emotional state indicates distraction, the server delays the delivery of generated information until a later observation of a relaxed or focused state, thereby controlling the timing of push notifications to the terminal.

The server, in the content selection module, determines which items to present to the user. The server maintains a content catalog that associates content identifiers with metadata such as topic tags, genre tags, and provider links. The server uses predictions from the user interest model to filter and rank items that are related to the subject of interest and have not yet been viewed or browsed by the user. The server then attaches the generated explanations from the generative AI model to these items and prepares a response payload for transmission to the terminal.

The terminal receives the response payload and stores it temporarily in a local memory. The terminal renders the titles, explanations, and other text data on the display as a list of selectable items. The terminal may display additional information such as confidence scores or tags derived from the server. The user operates an input device such as a touchscreen to select an item, open details, or initiate playback of associated media.

The terminal records user interactions as events, each event including at least a user identifier, a content identifier, an event type (for example, “opened”, “completed”, “liked”, “disliked”), and a timestamp. The terminal transmits these events to the server through the network interface. The server writes the events into the interaction-event table. The server uses these updated records in subsequent training iterations of the statistical learning module.

The server, in the logging module, also records the prompt sentences and the corresponding generated text data. The server associates these logs with later user responses such as browsing time and evaluation scores. The server, in a batch analysis mode, processes this log to estimate correlations between features of the prompt sentences (for example, length, explicitness of instructions, ordering of constraints) and the resulting user responses. The server uses these correlations to adjust the rules for constructing prompt sentences, for example by favoring templates and wording patterns that historically yield longer engagement or higher evaluation scores.

In another embodiment, the server maintains multiple sets of rules for constructing prompt sentences. One set is optimized for exploration of unknown fields, another is optimized for deep investigation of known fields, and another is optimized for mood improvement. The server switches between these sets dynamically based on the user interest model and the emotional state. This non-conventional use of prompt construction as a tunable control interface between the recommendation logic and the generative AI model enables the server to adapt the behavior of the generative AI model without modifying its internal parameters, thereby reducing the frequency and cost of retraining the generative AI model itself.

Because the server constructs prompt sentences using internal state variables (latent preference vectors, emotion probabilities, and engagement statistics), the server performs computations that would be impractical or impossible for a human operator to execute manually in real time. These computations include matrix operations over thousands of dimensions, probabilistic inference over large topic spaces, and optimization of multiple objectives such as relevance, diversity, and emotional alignment. The resulting architecture does not merely automate human editorial tasks but improves the operation of the computer system as a whole by reducing redundant generative calls, increasing the probability that generated outputs are accepted or consumed, and lowering network traffic associated with unhelpful content.

The server achieves technical effects in several ways. By using latent user interest models and emotion-aware prompt selection, the server reduces the number of generations needed to obtain acceptable content, thereby decreasing processing time and cloud compute usage. By filtering out content that the user has already consumed and by selecting unknown related fields via vector similarity operations, the server reduces unnecessary data transmission and storage usage. By logging and analyzing correlations between prompt features and user responses, the server automatically refines prompt construction rules, which increases the precision of future generations and lowers the rate of irrelevant or low-quality outputs. This feedback loop improves the efficiency and accuracy of the computing system's information generation function over time.

In a variation, the server executes the statistical learning module and the emotion analysis module on specialized hardware accelerators such as graphics processing units or tensor processing units. The server schedules mini-batch training operations during low-traffic periods to minimize interference with real-time request handling. In another variation, the terminal executes a simplified emotion classifier locally, using a smaller neural network that outputs a coarse emotional state. The terminal then transmits only the emotional label to the server, thereby reducing communication bandwidth and improving privacy.

In another embodiment, the generative AI interaction module employs different generative AI models for different purposes. For example, one generative AI model is configured with a smaller architecture to generate short summaries efficiently, while another generative AI model with a larger architecture is used for generating detailed explanatory articles. The server selects which generative AI model to invoke based on the selected prompt template and the emotional state, thereby optimizing computational resources and response latency.

In yet another embodiment, the server applies data augmentation techniques to the behavior history information, such as adding noise to numerical features or synthesizing interaction events based on patterns observed across similar users. The server uses these augmented data during training of the user interest model, which increases robustness against sparse or noisy user histories and yields more stable predictions of interest scores. The improved predictions lead to better prompt construction and more relevant generated content.

The described embodiments illustrate that the server, terminal, and user interact through specific data structures, algorithms, and model architectures that are arranged to achieve an improvement in computer technology itself. The server's controlled construction and adaptation of prompt sentences, combined with emotion-aware timing and content adjustment, result in a system that optimizes the internal flow of data, the use of computational resources, and the quality of machine-generated information beyond mere automation of human editorial decisions.

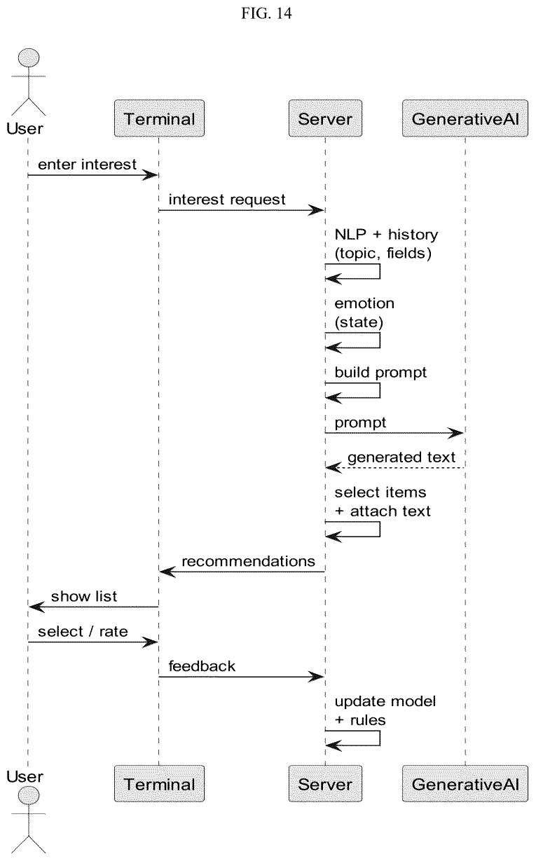

The following describes the processing flow using FIG. 14.

### Step 1

User operates the terminal to input interest information.

User types a free-form natural language phrase indicating a current interest (for example, “SF movies”, “AI technology”, or “environmental issues”) into a text field displayed on the terminal and triggers a send action (for example, by pressing a submit button).
Input: raw interest text entered by the user.
Output: a structured request message containing the user identifier and the interest text, prepared by the terminal.

Terminal converts the input text and a local user identifier into a structured message (for example, a JSON object with fields ‘user_id’ and ‘interest_text’), attaches a timestamp, and sends the message to the server over a network connection using a secure protocol.

### Step 2

Server receives and validates the interest request.

Server accepts the request message through a network interface, parses the message to extract the user identifier and the interest text, and performs basic validation such as checking length limits, character encoding, and presence of required fields.
Input: structured request message containing ‘user_id’ and ‘interest_text’.
Output: validated interest text and user identifier, or an error response if validation fails.

Server, when validation succeeds, logs the request in a request-log table and forwards the validated interest text and user identifier to downstream modules; when validation fails, server generates an error response and returns it to the terminal.

### Step 3

Server stores the interest text and updates behavior history.

Server writes a new record into a behavior history storage structure, associating the user identifier with the interest text, a request type (for example, “interest_query”), and a timestamp.
Input: validated user identifier and interest text.
Output: a new behavior history record stored in persistent storage and a reference to this record.

Server, by inserting this record into a user-profile-related table, ensures that subsequent learning processes can use this event as part of the user's long-term interaction data.

### Step 4

Server performs natural language preprocessing of the interest text.

Server applies a natural language processing module to the interest text to segment it into tokens, assign part-of-speech tags, and recognize named entities and key phrases.
Input: interest text string.
Output: a token sequence, associated part-of-speech tags, and a set of extracted key phrases and entities.

Server converts the interest text into Unicode code points, applies tokenization rules to identify word boundaries, uses a trained tagging model to assign grammatical roles, and applies an entity recognizer to detect domain terms such as genres and technical fields.

### Step 5

Server converts processed text into vector representations and identifies topics.

Server embeds tokens and key phrases into a continuous vector space and compares them with stored topic vectors to determine the most relevant subjects of interest and related fields.
Input: token sequence, key phrases, and entity list.
Output: one or more subject-of-interest identifiers and related-field identifiers, each with a similarity score.

Server multiplies token indices by an embedding matrix to obtain token vectors, aggregates token vectors (for example, by averaging or using a sequence encoder), and computes cosine similarity or inner products between this aggregate vector and stored topic vectors; server then selects top-ranked topics and classifies them as “subject of interest” and “related fields” according to predefined thresholds.

### Step 6

Server retrieves and preprocesses behavior history for the user.

Server queries the behavior history storage to obtain past interaction events for the user, including viewed content, dwell time, selection events, and evaluations, and converts these records into feature vectors suitable for model input.
Input: user identifier.
Output: a set of behavior feature vectors representing past interactions.

Server maps categorical fields such as content category and genre to numeric encodings, normalizes numeric fields such as viewing time, constructs feature vectors per event, and aggregates them per user (for example, by computing averages or weighted sums).

### Step 7

Server updates or executes the user interest model.

Server applies a statistical learning module to the behavior feature vectors in order to maintain or query a parametric interest model that assigns scores to topics for the user.
Input: behavior feature vectors and topic identifiers.
Output: a user-specific latent preference vector and predicted interest scores for candidate topics and content items.

Server, during training, computes a loss function (for example, mean squared error between predicted engagement and actual engagement), calculates gradients with respect to model parameters, and updates weights using an optimization algorithm; during inference, server forwards the feature vectors through the trained model to obtain numerical scores without changing parameters.

### Step 8

Server determines recommendation focus and unknown fields.

Server interprets the predicted scores and topic similarity scores to decide which related fields are likely unknown or underexplored for the user and should be emphasized in new information generation.
Input: subject-of-interest identifiers, related-field identifiers, and predicted interest scores.
Output: a selected main subject, a set of target related fields, and flags indicating whether the system aims at exploration, deepening, or mood improvement.

Server ranks related fields by combining interest scores and exposure metrics (for example, number of past interactions) and selects high-interest, low-exposure fields as targets for “unknown field exploration.”

### Step 9

Server estimates the user's emotional state.

Server analyzes recent user text, behavior patterns, and, in some embodiments, visual and audio data to classify the current emotional state.
Input: latest user text, behavior history segment, and optionally image frames and audio segments.
Output: an emotional state label (for example, curiosity, anxiety, relaxation, concentration) and a probability distribution over emotion categories.

Server converts text into embeddings and applies a classifier network, extracts visual features from image frames by a convolutional neural network and acoustic features from audio segments by a sequence model, and fuses these features to compute emotion probabilities; server then selects the emotion category with maximal probability and stores it as the current emotional state.

### Step 10

Server selects a prompt template based on interest and emotional state.

Server inspects the user interest model and the emotional state and chooses one of several stored templates designed for unknown field exploration, known field deep investigation, or mood improvement.
Input: subject-of-interest identifiers, related-field identifiers, user latent preference vector, and emotional state label.
Output: a selected prompt template identifier and its associated structure.

Server evaluates rule conditions that check, for example, whether exposure to a field is low, whether the user is anxious or curious, and whether the user requested more details, and then selects the template that satisfies the most conditions.

### Step 11

Server constructs a concrete prompt sentence.

Server fills variable slots in the selected template with specific topics, tone descriptors, and output-length constraints to form a complete natural language instruction for the generative AI model.
Input: selected template structure, subject-of-interest identifiers, related-field identifiers, emotional state, and target length values.
Output: a fully constructed prompt sentence string.

Server replaces placeholders in the template (for example, [SUBJECT], [RELATED_FIELDS], [TONE], [ITEM_COUNT]) with actual strings derived from the identified topics and emotional state, and concatenates them into a final instruction; typical outputs include sentences such as:
“User is interested in ‘SF movies’, especially cyberpunk and dystopian themes. Based on this, recommend 10 lesser-known SF films the user is unlikely to have seen, and explain in 2-3 sentences why each film matches these interests.”

### Step 12

Server sends the prompt sentence to the generative AI model and requests generation.

Server packages the prompt sentence in a request format accepted by the generative AI model and transmits it to a model endpoint.
Input: prompt sentence string and generation parameters (for example, maximum length, temperature).
Output: a generation request submitted to the generative AI model and a pending generation task identifier on the server side.

Server encodes the prompt sentence as token identifiers, includes them with generation parameters in a request structure, and sends this structure over a communication interface to a computing unit hosting the generative AI model.

### Step 13

Generative AI model produces text data in response to the prompt sentence.

Server receives token sequences generated by the generative AI model, which has executed multiple neural network layers to compute the output conditioned on the prompt sentence.
Input: prompt-encoded token sequence and model parameters stored on the model host.
Output: an output token sequence encoding the generated text data.

Server does not alter the internal model weights during this step; the model uses its trained parameters to perform forward passes, computing attention scores and probability distributions over output tokens, and then selects tokens according to the generation parameters.

### Step 14

Server decodes and post-processes the generated text data.

Server converts the output token sequence into characters, cleans up formatting, and optionally parses the text into structured recommendation entries.
Input: output token sequence from the generative AI model.
Output: human-readable generated text and, in structured form, a list of content descriptions with titles and explanations.

Server applies a tokenizer's inverse mapping to convert token indices to character strings, removes extraneous control tokens, splits the text at line breaks or numbered markers to form separate items, and assigns each item a title and explanation by simple parsing rules.

### Step 15

Server selects actual content items and associates them with generated explanations.

Server queries a content catalog to find items that match the subject of interest and related fields and that have not yet been consumed by the user, then attaches the generated explanations to these items.
Input: structured recommendation entries, user identifier, subject-of-interest identifiers, and behavior history.
Output: a ranked list of candidate content items, each with metadata and a generated explanation.

Server filters out items whose identifiers appear in the user's viewing history, computes a match score between catalog items and generated descriptions by comparing topic tags and keywords, and sorts the remaining items by a weighted combination of interest score and relevance to the generated text.

### Step 16

Server determines presentation timing based on emotional state and context.

Server decides whether to deliver the generated information immediately or to delay delivery until a more suitable emotional state or interaction context is detected.
Input: emotional state label, engagement metrics (for example, current session activity), and system policies.
Output: a scheduling decision indicating immediate delivery or delayed delivery with a scheduled time.

Server applies timing rules such as delivering in-depth technical content only when the emotional state indicates concentration and delaying non-urgent recommendations when the user appears distracted.

### Step 17

Server sends the recommendation payload to the terminal.

Server prepares a response message that includes the selected content items, generated explanations, and any additional metadata, and transmits this message to the terminal for presentation.
Input: ranked list of candidate content items with explanations, user identifier, and scheduling decision.
Output: a response payload delivered to the terminal.

Server serializes the list into a structured format, compresses the payload if necessary, and uses the network interface to send the payload to the terminal; server records the transmission event in a log for later analysis.

### Step 18

Terminal presents the generated information to the user.

Terminal receives the payload, parses it, and renders the content items and generated text in the user interface as selectable elements.
Input: response payload from the server.
Output: a visual and, optionally, audible presentation of recommended items and explanations on the terminal.

Terminal structures the display as a list or grid of cards containing titles, short explanations, and interaction controls such as “open”, “save”, or “like”, and updates the display buffer accordingly.

### Step 19

User interacts with the presented recommendations.

User selects one or more recommended items, views details, consumes associated content, and optionally provides explicit feedback such as ratings or comments through the terminal interface.
Input: displayed recommendations and controls.
Output: user actions such as selections, completions, ratings, and text feedback.

User may, for example, tap on a recommended movie to open further details, play a video, assign a rating score, or write a comment describing satisfaction or dissatisfaction.

### Step 20

Terminal logs user interactions and sends feedback to the server.

Terminal records each interaction event locally with attributes such as event type, content identifier, and timestamp, and periodically or immediately forwards these events to the server.
Input: user actions captured by the terminal.
Output: structured feedback messages containing interaction logs and, optionally, user-written text.

Terminal batches events when possible to reduce communication overhead, encodes them in a compact structure, and transmits them through the network to update the server's behavior history storage.

### Step 21

Server updates behavior history and emotion state based on feedback.

Server writes the received interaction events into the interaction-event table and may re-estimate the user's emotional state using new text feedback or behavior patterns.
Input: feedback messages from the terminal.
Output: updated behavior history records and, optionally, an updated emotional state label.

Server transforms the new events into feature vectors, aggregates them into the existing behavior history, and, if free-text feedback is included, applies the emotion analysis module to classify the tone of the user's comments.

### Step 22:

Server retrains or fine-tunes the user interest model and adjusts prompt construction rules.

Server incorporates the new behavior history into the training data for the interest model and uses logged prompt-response-reaction tuples to refine prompt construction strategies.
Input: updated behavior history, logged prompt sentences, generated texts, and associated user response metrics.
Output: updated model parameters, refined user latent preference vectors, and modified rules for constructing prompt sentences.

Server computes new gradients of the loss function on batches of recent data, updates model weights accordingly, revises rule thresholds for template selection based on observed correlations, and stores the new model state so that future executions of earlier steps operate with improved parameters and rules.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

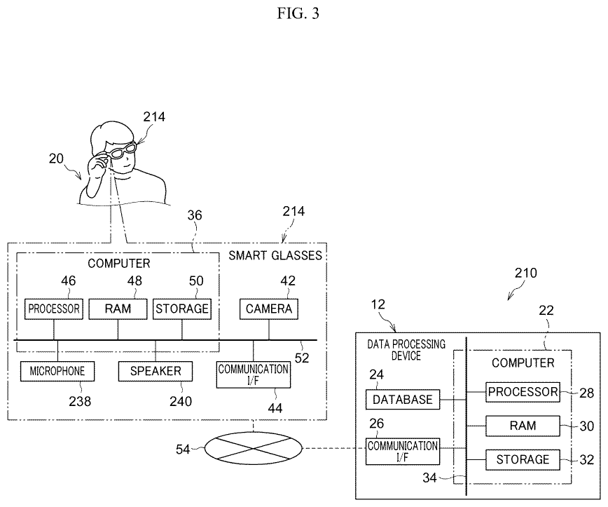

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

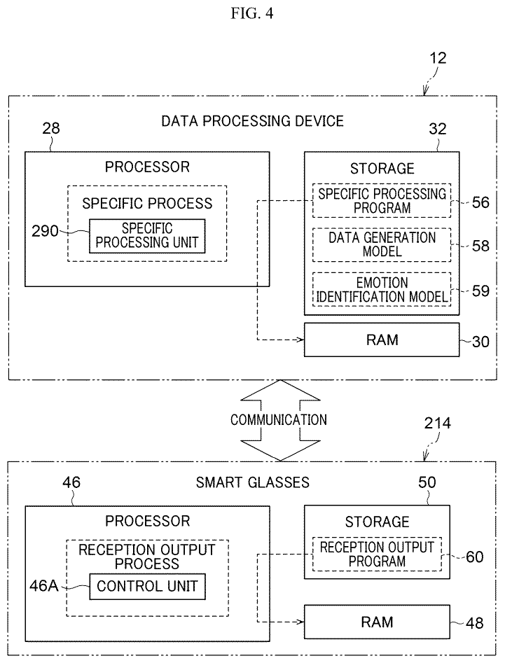

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

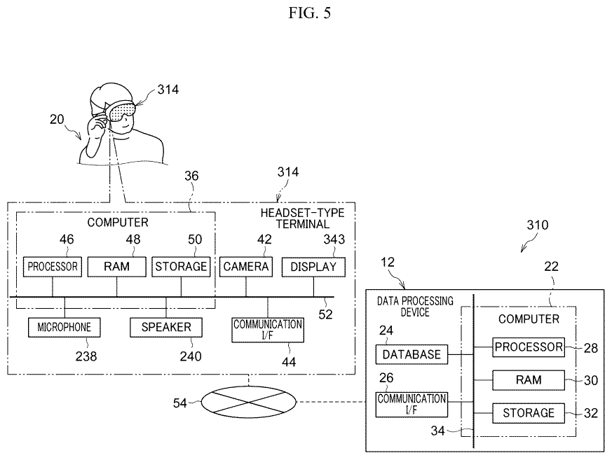

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

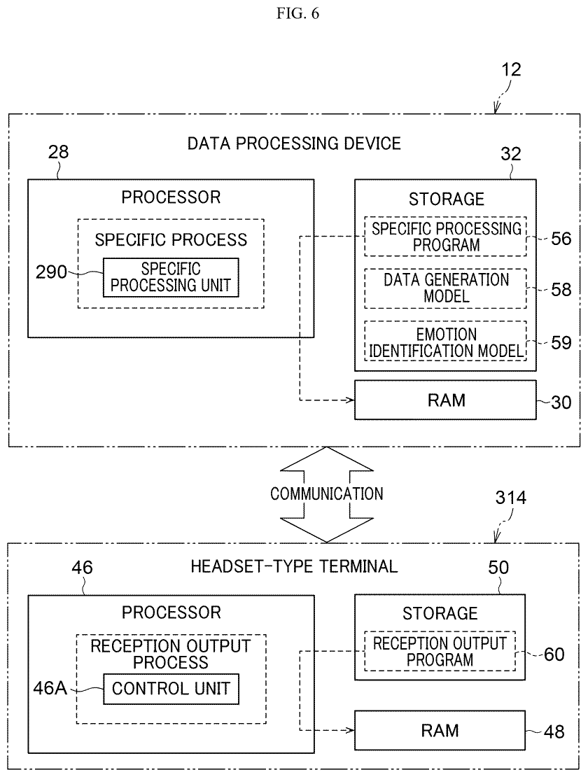

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

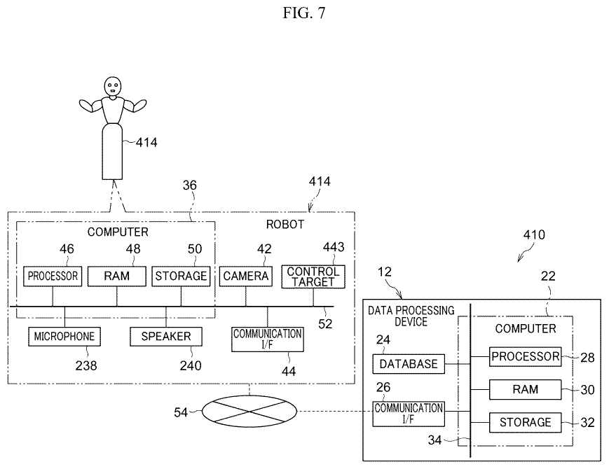

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

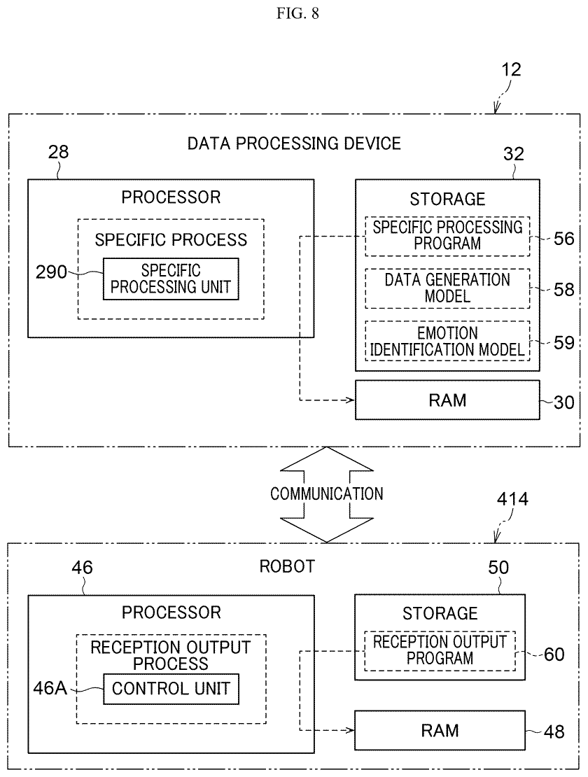

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

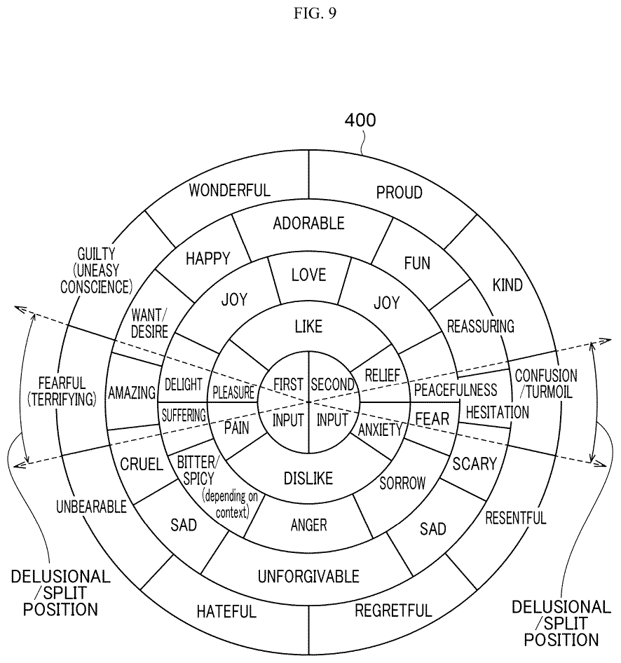

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

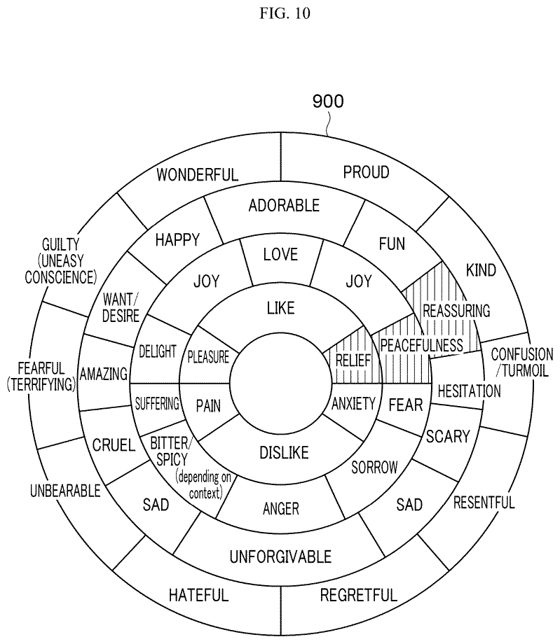

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive information indicating an interest of a user,
perform language processing on natural language data representing the interest of the user,
the language processing including segmentation processing, part-of-speech assignment processing, and contextual analysis processing, and generate structured information representing content of the interest by extracting subject information and auxiliary information from the natural language data,
generate a prompt sentence by embedding at least one instruction item including a target field, a level of explanation, and an output format into the structured information, and
generate generation instruction information that instructs information generation by using the prompt sentence,
input the generation instruction information into a pre-trained generative artificial intelligence model and acquire generated information including information related to the interest of the user and related to a field unknown to the user by using the generative artificial intelligence model,
convert the generated information into a structured data format having a hierarchical structure including heading information, summary information, and detailed information, and format the structured data format as document data for display, and
transmit the document data for display to a terminal device via a communication path and cause the terminal device to display the generated information.

### Supplementary 2

The system according to supplementary 1,
wherein the processor is configured to
use the generative artificial intelligence model as a probabilistic generative model trained in advance with a large-scale training information set, and cause the generative artificial intelligence model to output the generated information including explanatory information related to an unknown field, extension information related to a related field, and example information according to a knowledge level of the user, in accordance with the subject information and the auxiliary information included in the prompt sentence.

### Supplementary 3

The system according to supplementary 1
wherein the processor is configured to
define the structured information as an information structure including domain information indicating an interest field, emphasis information indicating a depth of interest, and control information indicating necessity of provision of additional knowledge, and, in generation of the prompt sentence, automatically incorporate instruction content that specifies in detail a description target, a description style, and an output configuration so that the generative artificial intelligence model outputs the generated information effectively based on the information structure.

### Application Example 1

### Supplementary 1

A system comprising a processor,
wherein the processor is configured to receive, via a terminal user interface, user interest information as natural language character data; and
analyze the received character data in an information processing apparatus via a communication network by executing a natural language processing program that performs at least one of morphological analysis, syntactic analysis, and phrase extraction, thereby extracting a plurality of terms or topics representing the user's interests; and
automatically generate a prompt sentence for instructing information generation by a generative artificial intelligence model by inserting the extracted terms or topics into a predetermined sentence template; and
input the automatically generated prompt sentence to the generative artificial intelligence model via the communication network and obtain, from the generative artificial intelligence model, information related to the user's interests and including a field that is unknown to the user; and
perform at least one post-processing operation including summarization, segmentation, heading generation, or topic extraction on the obtained information, thereby structuring the obtained information as article data or video configuration data for the user; and
store the structured data and the prompt sentence in a data storage device in association with user identification information, and make the stored data retrievable in response to a request from the terminal; and
collect behavior history data regarding at least one of viewing, selection, operation, and dwell time of the user on the terminal, update weight information for each topic of the user's interests based on the behavior history data, and automatically change content or structure of a subsequent prompt sentence using the updated weight information.

### Supplementary 2

The system according to supplementary 1,
wherein the processor is configured to generate, based on the prompt sentence and the weight information, a plurality of types of prompt sentences, obtain, by the generative artificial intelligence model, a plurality of types of data including at least one of article data of different lengths, summary data, and video configuration data corresponding to the respective prompt sentences, and store the plurality of types of data in the data storage device in a mutually associated manner.

### Supplementary 3

The system according to supplementary 1,
wherein the processor is configured to control the terminal to output, as a list screen and a detail screen, article data or video configuration data selected based on the weight information from among the structured data obtained from the information processing apparatus, and to display, on the detail screen, the prompt sentence input to the generative artificial intelligence model together with the selected data, thereby presenting to the user a condition under which the selected data has been generated.

### Example 2

### Supplementary 1

A system comprising a processor,
wherein the processor is configured to
receive, from a user terminal, character information indicating a user interest, and perform normalization and morphological analysis on the character information to extract concept information,
calculate candidate related concepts by using a natural language processing technique that converts the concept information into vector information, and select, from the candidate related concepts, a related concept corresponding to an unknown field with respect to the user on the basis of usage history information of the user,
acquire explanation information regarding the related concept corresponding to the unknown field from a knowledge storage device, and construct a prompt sentence including an instruction text for generating an explanation that expands the user interest,
input the prompt sentence and the explanation information into a generative artificial intelligence model that has been trained in advance using a large-scale data set, and obtain generated information including explanation information regarding the unknown field and information indicating a relationship between the unknown field and the user interest, and
generate output data including the generated information and transmit the output data to the user terminal so that the generated information is presented visually or audibly at the user terminal.

### Supplementary 2

The system according to supplementary 1,
wherein the processor is configured to calculate the candidate related concepts by using a similarity search storage device that stores vector information corresponding to the concept information and vector information corresponding to a plurality of concepts, and to specify the related concept corresponding to the unknown field on the basis of a similarity between the vector information corresponding to the concept information and the vector information corresponding to the plurality of concepts.

### Supplementary 3

The system according to supplementary 1,
wherein the processor is configured to construct the prompt sentence by using template information including the character information indicating the user interest, the related concept corresponding to the unknown field, and the explanation information acquired from the knowledge storage device, and to design the prompt sentence so as to include a specific instruction text that causes the generative artificial intelligence model to output the explanation information regarding the unknown field and the information indicating the relationship between the unknown field and the user interest.

### Application Example 2

### Supplementary 1

A system comprising a processor,
wherein the processor is configured to
acquire information regarding a user interest,
analyze the information regarding the user interest and behavior history information of the user by using natural language processing technology and statistical learning technology so as to specify a subject of interest of the user and a related field and to construct a prompt sentence for instructing generation of information in a related field not yet accessed by the user,
input the constructed prompt sentence to a trained generative information processing model so as to cause the generative information processing model to generate text data including information related to the user interest and not yet accessed by the user,
analyze an emotional state of the user on a basis of at least one of text input of the user, the behavior history information of the user, image information of the user, and sound information of the user, and adjust at least one of content, level of detail, tone, and presentation timing of the prompt sentence and the generated text data in accordance with the emotional state,
transmit the generated text data and information regarding related content not yet viewed or browsed by the user to a terminal device of the user so as to present the generated text data and the information regarding the related content to the user, and acquire feedback information regarding selection, browsing, and evaluation performed by the user, and
update a user interest model and rules for constructing the prompt sentence by using the natural language processing technology and the statistical learning technology on a basis of the feedback information and the behavior history information, so as to automatically improve content of a subsequent prompt sentence and subsequently generated information.

### Supplementary 2

The system according to supplementary 1,
wherein the processor is configured to
store a plurality of kinds of rules for constructing the prompt sentence, select a kind of the prompt sentence corresponding to one of exploration of an unknown field, deep investigation of a known field, and improvement of mood on a basis of the user interest model and the emotional state, and automatically generate the prompt sentence by inserting a subject of interest of the user, the related field, a recommended tone, and a target amount of information into a template corresponding to the selected kind.

### Supplementary 3

The system according to supplementary 1,
wherein the processor is configured to
record the prompt sentence input to the generative information processing model and the text data output from the generative information processing model, analyze at least one of browsing time, selection frequency, and evaluation information of the user with respect to the text data, estimate a correlation between an expression format and instruction content of the prompt sentence and a response of the user, and automatically change the expression format and the instruction content of the prompt sentence on a basis of the correlation.

What is claimed is:

1. A system comprising:
circuitry configured to:
receive, from a terminal device via a packet-switched network, natural language data indicating an interest specification of a user;
perform language processing on the natural language data comprising segmentation, part-of-speech assignment, and contextual analysis to generate structured information by extracting subject information and auxiliary information from the natural language data;
generate a prompt sequence by embedding into the structured information at least one instruction item specifying a target domain, an explanation depth parameter, and an output format specification, and generate generation instruction data based on the prompt sequence;
input the generation instruction data into a pre-trained generative information processing model to acquire generated information comprising information related to a field not previously associated with the interest specification of the user;
convert the generated information into a structured data format having a hierarchical structure comprising heading data, summary data, and detail data, and format the structured data format as document data; and
transmit the document data as data packets via the packet-switched network to the terminal device.

2. The system according to claim 1, wherein the circuitry is configured to convert the subject information extracted from the natural language data into vector representations by applying an embedding model, perform a similarity computation between the vector representations and stored vector representations corresponding to a plurality of concept entries in a vector search data structure, and identify candidate concept entries whose similarity metric exceeds a predetermined threshold.

3. The system according to claim 2, wherein the circuitry is configured to select, from the candidate concept entries, a concept entry corresponding to a field not present in usage history data of the user stored in an information storage structure, the usage history data comprising records of previously accessed concept entries associated with a user identifier.

4. The system according to claim 3, wherein the circuitry is configured to retrieve explanation data associated with the selected concept entry from a knowledge data structure, and embed the retrieved explanation data together with the subject information and the selected concept entry into template data to construct the prompt sequence, the prompt sequence comprising an instruction text directing the generative information processing model to generate explanation data regarding the selected concept entry and relationship data indicating a connection between the selected concept entry and the interest specification.

5. The system according to claim 1, wherein the circuitry is configured to define the structured information as an information structure comprising domain data indicating an interest field, emphasis data indicating a depth of interest, and control data indicating a requirement for provision of supplementary knowledge, and to incorporate into the prompt sequence instruction content specifying a description target, a description style, and an output configuration based on the information structure.

6. The system according to claim 5, wherein the generative information processing model is a probabilistic generative model trained on a large-scale training data set, and the circuitry is configured to cause the generative information processing model to output the generated information comprising explanatory data related to the field not previously associated with the interest specification, extension data related to an adjacent field, and example data corresponding to an inferred knowledge level of the user.

7. The system according to claim 6, wherein the circuitry is configured to perform postprocessing on the generated information comprising at least one of summarization, segmentation into sections, heading generation, and topic label extraction, to produce structured article data or content configuration data for the user.

8. The system according to claim 1, wherein the circuitry is configured to collect behavior history data from the terminal device comprising at least one of viewing event data, selection event data, operation event data, and dwell time data, and to compute updated weight values for each topic associated with the interest specification based on the behavior history data, and to modify content or structure of a subsequent prompt sequence using the updated weight values.

9. The system according to claim 8, wherein the circuitry is configured to generate, based on the prompt sequence and the updated weight values, a plurality of variant prompt sequences, obtain from the generative information processing model a plurality of output data items comprising at least one of article data of different length specifications, summary data, and content configuration data corresponding to the respective variant prompt sequences, and store the plurality of output data items in a data storage structure in mutual association.

10. The system according to claim 9, wherein the circuitry is configured to control the terminal device to display the article data or content configuration data selected based on the updated weight values, and to present on a detail display the prompt sequence that was input to the generative information processing model together with the selected data, thereby providing a transparency indicator of the generation condition.

11. The system according to claim 1, wherein the circuitry is configured to store the prompt sequence and the generated information in a data storage structure in association with a user identifier, and to make the stored data retrievable in response to a subsequent request from the terminal device.

12. The system according to claim 1, wherein the generative information processing model comprises a transformer architecture having an embedding layer, a plurality of self-attention layers, and a decoding layer configured to generate output tokens sequentially based on probability distributions conditioned on the generation instruction data.

13. The system according to claim 12, wherein the circuitry is configured to apply a token-level decoding strategy comprising at least one of greedy decoding, beam search with a beam width parameter, and nucleus sampling with a probability threshold parameter.

14. The system according to claim 1, wherein the circuitry is configured to analyze an emotional state of the user based on at least one of text input data from the terminal device, behavior history data, image data, and audio data, and to adjust at least one of content, detail level, tone, and presentation timing of the prompt sequence and the generated information in accordance with the analyzed emotional state.

15. The system according to claim 14, wherein the emotional state analysis comprises mapping the text input data or audio data to a position in a feature space defined by a valence axis and an arousal axis, and selecting a tone adjustment parameter based on the mapped position.

16. The system according to claim 1, wherein the circuitry is configured to receive, from the terminal device, feedback data comprising at least one of a rating value, a free-text evaluation, and a selection indicator with respect to the transmitted document data, and to update the interest specification and the prompt sequence generation parameters based on the received feedback data.

17. The system according to claim 1, wherein the circuitry is configured to apply collaborative filtering by computing similarity between the usage history data of the user and usage history data of a plurality of other users to identify concept entries accessed by the plurality of other users but not by the user, and to incorporate at least one identified concept entry into the prompt sequence as additional context for the generative information processing model.

18. A system comprising:
circuitry configured to:
receive natural language data indicating an interest specification of a user from a terminal device;
perform language processing on the natural language data to extract subject information and auxiliary information, and convert the subject information into vector representations;
perform a similarity search between the vector representations and stored concept vectors to identify candidate concept entries, and select a concept entry corresponding to a field not present in usage history data of the user;
generate a prompt sequence by embedding the subject information, the selected concept entry, and retrieved explanation data into template data comprising instruction text;
input the prompt sequence into a generative information processing model and obtain generated information comprising explanation data and relationship data;
convert the generated information into a hierarchical data format and transmit the formatted data as data packets via a packet-switched network to the terminal device; and
collect behavior history data from the terminal device and update weight values for subsequent prompt sequence generation.

19. The system according to claim 18, wherein the circuitry is configured to analyze an emotional state of the user and adjust at least one of content and tone of the prompt sequence and the generated information based on the emotional state.

20. A method performed by circuitry of a system, the method comprising:
receiving, from a terminal device via a packet-switched network, natural language data indicating an interest specification of a user;
performing language processing on the natural language data comprising segmentation, part-of-speech assignment, and contextual analysis to generate structured information by extracting subject information and auxiliary information;
generating a prompt sequence by embedding into the structured information at least one instruction item specifying a target domain, an explanation depth parameter, and an output format specification;
inputting generation instruction data based on the prompt sequence into a pre-trained generative information processing model to acquire generated information comprising information related to a field not previously associated with the interest specification;
converting the generated information into a structured data format having a hierarchical structure comprising heading data, summary data, and detail data; and
transmitting the structured data format as data packets via the packet-switched network to the terminal device.
